(19) United States
(12) Patent Application Publication
(10) Pub. No.: US 2013/0317987 A1
(43) Pub. Date: Nov. 28, 2013

(54) TRANSACTION MANAGEMENT SYSTEM

(71) Applicant: Yuichiro Tsutsui, Tokyo (JP)

(72) Inventor: Yuichiro Tsutsui, Tokyo (JP)

(73) Assignees: JCM AMERICAN CORPORATIONS, Las Vegas, NV (US); TECHFIRM INC., Tokyo (JP)

(21) Appl. No.: 13/481,490

(22) Filed: May 25, 2012

(51) Int. Cl. G06Q 20/40

(52) U.S. Cl. 705/44

(57) ABSTRACT

A transaction management apparatus is provided, which comprises a request receiving section receiving a transaction request containing a transaction requesting amount indicating an amount of a transaction of local credits used by a user in a limited environment and a user's identification information; a storing section storing a first balance and a second balance, corresponding to the identification information, the first balance indicating a balance of first credit and the second balance indicating a balance of second credit with a larger limitation of use purposes than the first credit; a judging section judging whether the transaction is allowed based on a result of comparing the transaction requesting amount with the first and second balance corresponding to the identification information; and a managing section changing the first and second balance stored in the storing section based on the transaction requesting amount, when the judging section judges the transaction is allowed.

### BACKGROUND

1. Technical Field

The present invention relates to a transaction management system for managing transactions of local credits.

2. Related Art

Payment systems that enable payments for services provided in facilities such as a casino or a hotel by using a private or house card usable only in the facilities are known. For example, Japanese Patent Unexamined Publication No. 2002-123619 discloses a system that enables a user to obtain various services such as a meal, a game, shopping, or an accommodation in the facilities based on the information that is recorded in the card.

Also, Japanese Patent Unexamined Publication No. 2009-48376 discloses a payment system that enables a user to use a house card for service costs up to the amount of the credit line of the corresponding credit card when the user wants to use a service beyond the user-predetermined deposit amount that was stored on the house card.

Japanese Patent Unexamined Publication No. 2001-243376 discloses a method of providing points to the user who purchased goods, and of enabling the user to use the points as part of cash payments for future purchases.

However, the conventional payment system only enabled the user to use the service by presenting the house card when using the service by paying money in advance. Therefore, although the user's convenience is improved in comparison with the case of paying money every time to use the services, motivation for buying specific services or goods was not able to be generated.

By providing some points, generating motivation to purchase goods in the same shop in the future was possible. However, the points were only able to make up for a part of the purchase price when purchasing the goods. Also, since the points were not managed together with cash that the user had, the user was not able to easily figure out the amount that could be used towards purchases.

### SUMMARY

Therefore, it is an object of an aspect of the innovations to provide a transaction management apparatus, a transaction management system, and a transaction management method, which are capable of solving the above-mentioned problems. This object is achieved by combinations of the features described in the claims.

According to the first aspect of the present invention, a transaction management apparatus that manages transactions of local credits that can be used by a user in a limited environment is provided. The transaction management apparatus comprises a request receiving section that receives a transaction request containing a transaction requesting amount indicating an amount of the transaction and identification information unique to the user; a storing section that stores a first balance and a second balance, in association with the identification information, the first balance indicating a balance of a first credit and the second balance indicating a balance of a second credit with a larger limitation of use purposes (more restricted in use) than the first credit; a judging section that judges whether or not the transaction is allowed based on a result of comparing the transaction requesting amount with at least one of the first balance and the second balance corresponding to the identification information; and a managing section that changes at least one of the first balance and the second balance stored in the storing section based on the transaction requesting amount, when the judging section judges that the transaction is allowed.

According to the second embodiment of the present invention, a transaction requesting apparatus that requests transactions of local credits that can be used by a user in a limited environment is provided. The transaction requesting apparatus comprises an acquiring section that acquires an instruction regarding the transaction of local credits; a sending section that sends, according to the instruction, a balance request for a first balance indicating a balance of a first credit and a second balance indicating a balance of the second credit to the transaction management apparatus that manages the first balance and the second balance; a receiving section that receives the first balance and the second balance from the transaction management apparatus; and a display section that displays the first balance and the second balance.

According to the third embodiment of the present invention, a transaction management system comprising a transaction requesting apparatus that requests transactions of local credits that can be used by a user in a limited environment and a transaction management apparatus that manages whether or not a transaction is allowed in response to a transaction request received from the transaction requesting apparatus is provided. The above-mentioned transaction requesting apparatus includes a sending section that sends the transaction request containing identification information of the user and a transaction requesting amount of the transaction. The above-mentioned transaction management apparatus includes the storing section that stores a first balance and a second balance, in association with the identification information, the first balance indicating a balance of a first credit and the second balance indicating a balance of the second credit with a larger limitation of use purpose than the first credit, a judging section that judges whether or not the transaction is allowed based on a result of comparing the transaction requesting amount with the first balance and the second balance corresponding to the identification information, and a managing section that changes the first balance and the second balance stored in the storing section based on the transaction requesting amount, when the judging section judges that a transaction is allowed.

The summary of the invention does not include all the features required for the present invention. The present invention may also be a sub-combination of the features described above.

### BRIEF DESCRIPTION OF THE DRAWINGS

FIG. 1A shows the configuration of the transaction management system 10 according to the present embodiment.

FIG. 1B shows the relationship between the transaction management system 10 and other systems in the present embodiment.

FIG. 2 shows an example of display screen image of the wireless information terminal 300.

FIG. 3 shows a configuration of a transaction management apparatus 100 according to the present embodiment.

FIG. 4 shows the first example of identification information, the first balance and the second balance that are stored in the storing section 120.

FIG. 5 shows a flowchart of an operation of the transaction management apparatus 100 in the present embodiment.

FIG. 6 shows a configuration of the transaction requesting apparatus 200 of the present embodiment.

FIG. 7 shows another example of the transaction requesting apparatus 200 of the present embodiment.

FIG. 8A shows the relationships between the first balance and the second balance; as well as the first usable balance and the second usable balance.

FIG. 8B shows the relationships between the first balance and the second balance; as well as the first usable balance and the second usable balance.

FIG. 9 shows an example of the display screen of the transaction requesting apparatus 200.

FIG. 10A shows an example of the communication sequence in the transaction management system 10 according to the present embodiment.

FIG. 10B shows another example of the communication sequence in the transaction management system 10 according to the present embodiment.

FIG. 11 shows another example of a communication sequence in the transaction management system 10 of the present embodiment.

FIG. 12 shows an example of the wireless information terminal 300.

FIG. 13 shows another example of the communication sequence in the transaction management system 10 of the present embodiment.

FIG. 14 shows the second example of identification information, the first balance and the second balance that are stored in the storing section 120.

FIG. 15 shows an example of the transaction request that is sent by the sending section 220.

FIGS. 16A to 16D show the display of the wireless information terminal 300 that displays the balance matching the use conditions.

FIG. 17 shows the third example of the identification information, the first balance and the second balance that is stored by the storing section 120.

FIG. 18 shows an example of the relationship between time and the balance of local credit.

FIG. 19 shows another example of the relationship between time and the balance of local credit.

FIG. 20 shows an example of the location of the wireless information terminal 300 that functions as a transaction requesting apparatus 200.

### DESCRIPTION OF EXEMPLARY EMBODIMENTS

### Description of the Embodiment

Hereinafter, the present invention will be described through embodiments of the present invention. The following embodiments do not limit the claimed inventions, and all of the combinations of the features that are described in the embodiment are not always essential for the means for solving the problems of the invention.

[Configuration of the Transaction Management System 10]

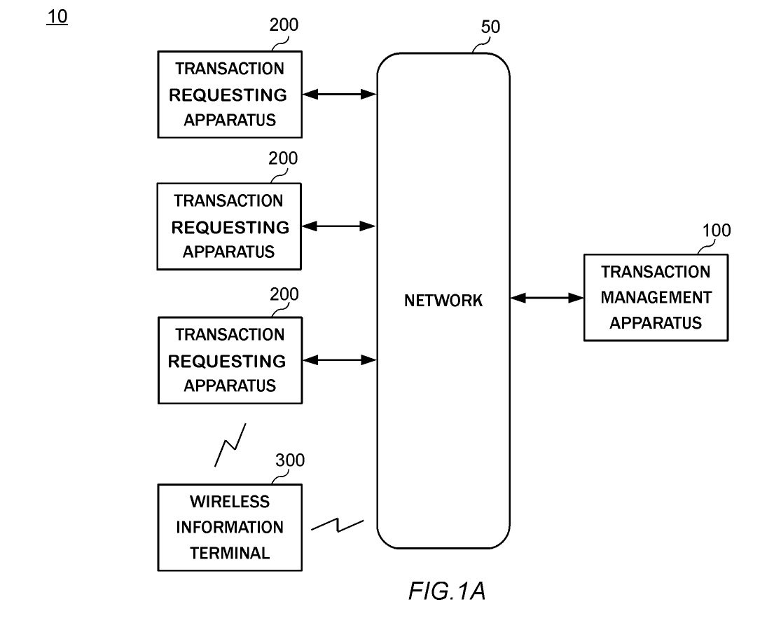

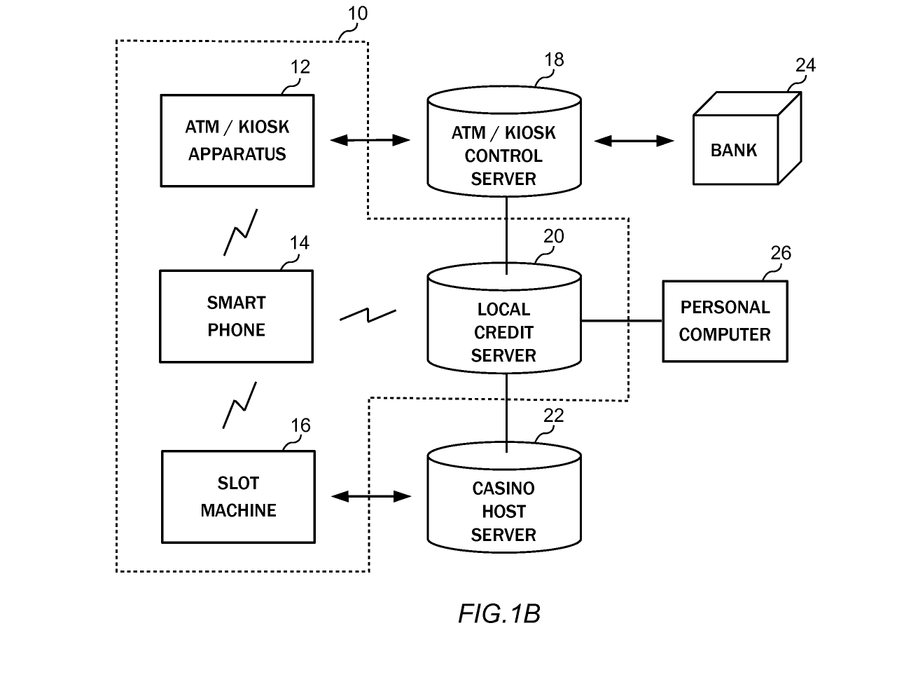

FIG. 1A shows a configuration of a transaction management system 10 according to the embodiment. The transaction management system 10 comprises a transaction management apparatus 100 and a transaction requesting apparatus 200. The transaction management system 10 may further comprise a wireless information terminal 300. The transaction management system 10 may comprise a plurality of the transaction requesting apparatuses 200 and a plurality of wireless information terminals 300.

The transaction management system 10 and the transaction requesting apparatus 200 are connected through a network 50. The network 50 is, for example, the internet. A network 50 may be a LAN (a local area network).

A transaction management system 10 is, for example, a server that manages a balance or a possibility of use of a local credit, which a user can use in facilities such as a casino or a restaurant that provides goods or services. Here, a user is an individual person or a company that are provided goods or services in the above mentioned facilities. The transaction management apparatus 100 may memorize identification information unique to a user.

A local credit is a credit with a monetary value that can be used in limited environments by a user. Specifically, a local credit can be used in the environment where accessing a transaction management apparatus 100 is possible, and cannot be used in other environments where accessing a transaction management apparatus 100 is not possible.

For instance, a user is able to play a game in a slot machine at a casino by using local credit, pay for a meal with a checking out machine at a restaurant by using local credit, pay for the goods with a POS (point-of-sales) terminal at a shop by using local credit, or settle a hotel bill by using local credit in the facilities managed by a transaction management system 10. A user may make a payment by local credit by using a mobile information terminal that can access the transaction management system 10.

A transaction requesting apparatus 200 sends a transaction request to a transaction management apparatus 100 according to instructions from a user. The transaction requesting apparatus 200 may send a transaction request to a transaction management apparatus 100 through a plurality of networks or servers. A transaction is a process to increase or to decrease local credit.

Here, a transaction that increases local credit is a process to increase the money amount that is able to be used as local credit, and is called as “recharge transaction” in this specification. A transaction that decreases local credit is a process to purchase a good or a service by using local credit, and is called a “payment transaction” in this specification. A transaction request is a message requesting for a transaction.

A transaction requesting apparatus 200 is located in a facility where local credit can be used, and is an apparatus to make payments by using local credit or to recharge local credit. For instance, the transaction requesting apparatus 200 is a game apparatus located in a casino, an ATM (automated teller machine) or a POS (point-of-sales) terminal. The transaction requesting apparatus 200 may be a check out machine that is located at a restaurant or a shop, or a computer. A wireless information terminal 300 such as a smartphone that a user owns may function as a transaction requesting apparatus 200.

For example, a user can play a game by using local credit in a transaction requesting apparatus 200 that has a game function such as a slot machine. A user is able to play a game by using the balance stored as local credit, and to exchange the prize money obtained in the game to increase the local credit. In a second example, a user can exchange cash into local credit by using a transaction requesting apparatus 200 that has an ATM function. In another example, a user can make a payment by using local credit in the ATM.

In a further example, a clerk of a shop, where a transaction requesting apparatus 200 that has a function of a POS terminal is installed, can check out goods by using the transaction requesting apparatus 200. The transaction requesting apparatus 200 that functions as a POS terminal can acquire the identification information unique to the customer that purchases goods, and can check out the goods by using the corresponding customer's local credit.

A wireless information terminal 300 has an operating section and a display section. The wireless information terminal 300 can transmit data or voice through a wireless communication line. For example, the wireless information terminal 300 may send and/or receive the data between the transaction requesting apparatus 200 through a near field communication (NFC). In a further example, the wireless information terminal 300 may send and/or receive the data with a transaction management apparatus 100 through a Wi-Fi connection or a mobile phone line.

FIG. 1B shows the relationship between the transaction management system 10 and other systems in the present embodiment. The area that is surrounded by dotted lines corresponds to the transaction management system 10. The transaction management system 10 in FIG. 1B comprises a local credit server 20 that functions as a transaction management apparatus 100, an ATM/KIOSK apparatus 12 and a slot machine 16 that each functions as a transaction requesting apparatus 200, and a smart phone 14 that functions as a transaction requesting apparatus 200 and a wireless information terminal 300.

The ATM/KIOSK apparatus 12 is connected to an ATM/KIOSK control server 18 that manages the balance of an account in the bank 24. The slot machine 16 is connected to a casino host server 22 that manages the customers' information of a casino. The local credit server 20 may communicate with the ATM/KIOSK apparatus 12 through the ATM/KIOSK control server 18, and may communicate with the slot machine 16 through the casino host server 22.

In one example, when the local credit server 20 receives the request from the smart phone 14 for exchanging the money deposited in an account of the bank 24 to local credit, the local credit server 20 makes a request to the ATM/KIOSK control server 18 for payment. As a second example, when a user operates to exchange the money deposited in an account of the bank 24 to a local credit by using the ATM/KIOSK apparatus 12, the local credit server 20 receives the request to increase local credit from the ATM/KIOSK control server 18.

For instance, when a user is playing a slot machine 16, the local credit server 20 transfers a part of local credit to the slot machine 16 through the casino host server 22. The local credit server 20 may receive the prize money that a user obtained at the slot machine 16 through the casino host server 22, and may increase the local credit of the user. Additionally, the manager of the transaction management system 10 may increase the local credit of the user by using the personal computer 26 that is connected to the local credit server 20, such as might be done to implement a player reward.

Hereinafter, operations of the transaction management system 10 will be explained with reference to FIG. 1A. A transaction management system 10 manages a first category of the local credit (hereinafter, a first credit) and a second category of the local credit (hereinafter, a second credit) with a larger limitation of use purposes than that of the first credit. The first credit is, for example, a local credit that can be exchanged to and from, only from, or only to circulating money such as 10 cent coin or 1 dollar bill. The second credit is, for example, a local credit that can neither be exchanged from circulating money nor be exchanged to circulating money. Here, purchasing the second credit that has a value different from the circulating money by using circulating money is different from an exchange, and the transaction management system 10 may allow the user to purchase the second credit by using circulating money.

For example, a user can exchange a whole or a part of the first credit balance to cash. A user can make a payment of a goods or a service by using a whole or a part of the second credit in a transaction requesting apparatus 200.

A company or an individual person that uses the transaction management system 10 can issue a local credit in various ways. For example, a casino operating company that introduced the transaction management system 10 issues a second credit that corresponds to the identification information unique to a customer to encourage the customer to try out various services. In another example, a shop that introduced the transaction requesting apparatus 200 that functions as a POS terminal may issue a second credit corresponding to the identification information unique to a customer to encourage the customer to visit the shop.

An individual user that uses a casino or a hotel that introduced the transaction management system 10 can exchange circulating money to a first credit by using the transaction requesting apparatus 200 located at the casino or the hotel. Optionally, the transaction management system 10 may set a limit on the amount of the first credit that can be exchanged to cash and issued to the individual user.

When a first credit or a second credit is used in a first use condition, the transaction management system 10 may issue the second credit limited with a second use condition matching, or associated with, the first use condition. The use condition herein is an index that categorizes the goods or services provided in the facilities, the index including at least one of the following: types of goods or services that are purchased by a second credit; types of companies that provide the goods or services; types of shops; areas in the facilities; a time-zone when the goods or services are purchased; and a usable period (effective period).

For example, when a user pays for a meal at a casino-associated restaurant by using a first credit or a second credit, the transaction management system 10 gives a second credit that is usable at the casino to the user. Or, when a user buys clothes by using a first credit or a second credit at a casino-associated retailer, the transaction management system 10 gives a second credit that is usable for meals at a casino-associated restaurant or for playing at the casino's slot machines.

The transaction management apparatus 100 manages a transaction of the local credit that a user can use. Specifically, the transaction management apparatus 100 manages the balance that can be used for a transaction of local credit. More specifically, the transaction management apparatus 100 manages the first balance indicating a balance of the first credit that can be used by the user and the second balance indicating a balance of the second credit that can be used by the user. Also, the transaction management apparatus 100 manages whether or not a transaction is allowed in response to a transaction request received from the transaction requesting apparatus 200.

For example, the transaction management apparatus 100 stores a balance of local credit that can be used by a user. The transaction management apparatus 100 permits a user to use a local credit according to the request for using the local credit acquired from a user through the transaction requesting apparatus 200, and carries out a payment transaction decreasing the archived balance of the local credit. The transaction management apparatus 100 may carry out a recharge transaction increasing the archived balance of the local credit upon receiving the payment by cash or by a credit card according to the instructions for increasing the balance of the local credit by a user.

Also, optionally, the transaction management system 10 may forbid recharging a first credit by using a credit card in order to prevent a first credit from exchanging to circulating money with a low rate by using a credit card. Specifically, in this situation, when the transaction request shows that a credit card is used for the transaction, the transaction management apparatus 100 forbids increasing the first balance. In this case the transaction management apparatus 100 may notify the transaction requesting apparatus 200 of not being able to increase a first credit by using a credit card when a user is going to increase the first balance to use a first credit by using a credit card.

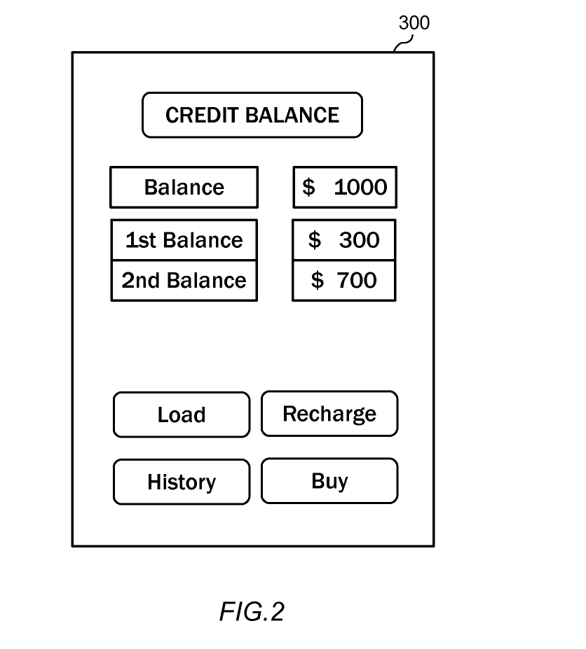

FIG. 2 shows an example of the display screen image of the wireless information terminal 300. The wireless information terminal 300 as shown in FIG. 2 shows that: the local credit balance that a user can use is $1000; the first credit balance is $300; and the second credit balance is $700. For example, after downloading and installing application software for using the transaction management system 10 and after the user logs into the application, the wireless information terminal 300 can display the screen as shown in FIG. 2.

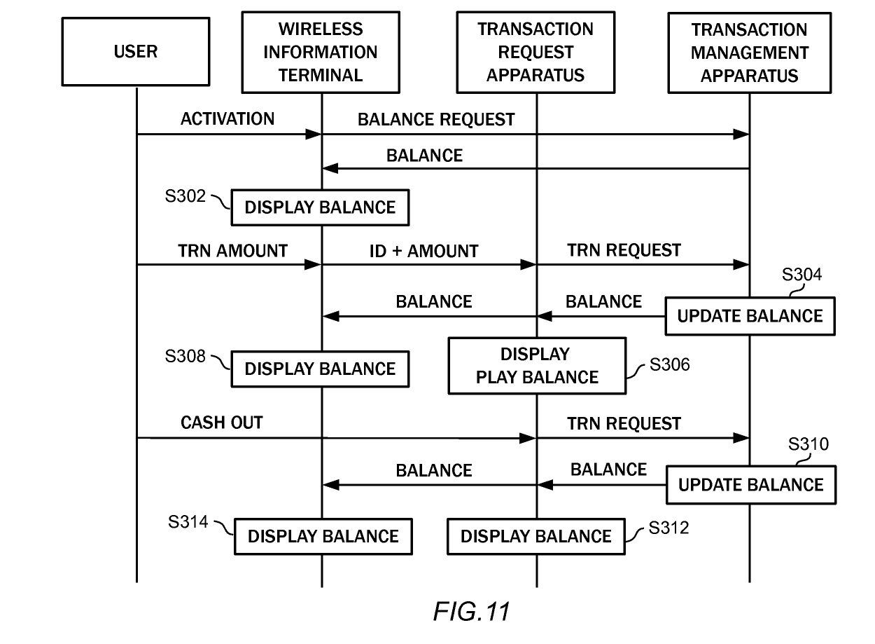

A user can transfer a whole or a part of the first balance or the second balance to the transaction requesting apparatus 200 by pushing the Load button. For example, when a transaction requesting apparatus 200 functions as a slot machine, the user can play by using at least one of the transferred first balance or the transferred second balance. The operations of the wireless information terminal 300, the transaction requesting apparatus 200, and the transaction management apparatus 100 when the Load button is pushed will be explained later in reference to FIG. 11.

When the user pushes the Recharge button, the wireless information terminal 300 displays a screen for inputting the amount to recharge the first credit. When the user inputs the requested amount to recharge, the wireless information terminal 300 sends a transaction request with a transaction request amount that corresponds to the inputted amount. After receiving the updated first balance after recharging, the wireless information terminal 300 displays the updated first balance, the second balance, and the total balance amount.

When the user pushes the History button, the wireless information terminal 300 displays the histories of payments and recharges of the local credit. The wireless information terminal 300 may display the history of each of the transactions of the first credit and the history of each of the transactions of the second credit.

When the user pushes the Buy button, the wireless information terminal 300 displays images of products that can be bought by using at least one of the first credit or the second credit. The user can buy the products by pushing the displayed images of the products.

As explained above, since the first credit and the second credit are managed by corresponding them to the user's identification information according to the transaction management system 10, the companies that introduced the transaction management system 10 and the shops that use the transaction management system 10 can lock-in users and encourage the purchase of goods and services by issuing the first credit and the second credit according to a marketing strategy.

A company that uses the transaction management system 10, for example, can motivate a user to purchase goods or services at the same facility or associated facilities by providing the second credit that cannot be exchanged for circulating money. For example, the company that uses the transaction management system 10 can provide a complimentary second credit to a user in an amount of the first credit.

Furthermore, since the company that introduced the transaction management system 10 can strategically select a user to whom the second credit is issued, and can determine to a very specific level the activities, status and purchases of the user, a better marketing strategy is able to be constructed.

For a user, there is an advantage of being able to obtain goods and services without moving cash into or out of a wallet in a facility where local credit can be used. In particular, since the local credit that a user purchased and the local credit issued by a company can be managed together, a user can easily grasp how much of goods or services the user can purchase.

[Configuration of the Transaction Management Apparatus 100]

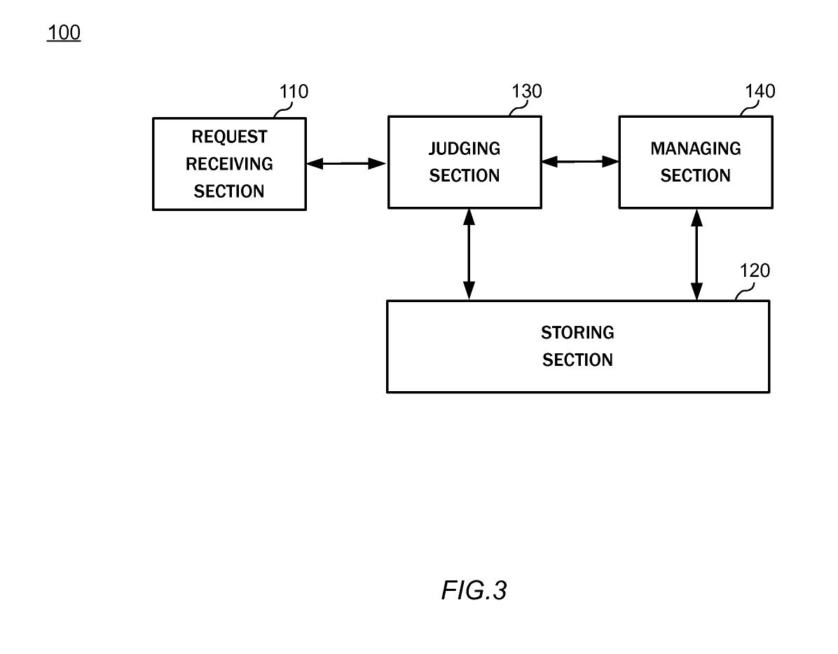

FIG. 3 shows a configuration of a transaction management apparatus 100 according to the present embodiment. A transaction management apparatus 100 comprises a request receiving section 110, a storing section 120, a judging section 130, and a managing section 140. The request receiving section 110 receives a transaction request that contains a transaction requesting amount indicating the amount of the transaction and identification information unique to a user. For example, a request receiving section 110 receives a transaction request from a transaction requesting apparatus 200 or a wireless information terminal 300.

Specifically, the request receiving section 110 receives a transaction requesting amount that shows how much local credit a user wants to use, or a transaction requesting amount that shows how much a user wants to increase a local credit from the user. The request receiving section 110 may receive a transaction request that contains information that shows the type of a transaction, either a payment transaction or a recharge transaction.

For example, the request receiving section 110 receives a transaction request containing at least one of the following: a transaction requesting amount indicating an amount of the transaction of the first credit; or a transaction requesting amount indicating an amount of the transaction of the second credit that has a different usable range from the first credit.

The request receiving section 110 receives identification information of a user from the transaction requesting apparatus 200. Specifically, the request receiving section 110 receives the user's identification information that is received from the wireless information terminal 300 through a near field communication by the transaction requesting apparatus 200 and is stored in a non-volatile memory of the user's wireless information terminal 300. The request receiving section 110 may directly receive identification information from the wireless information terminal 300.

The storing section 120 stores a first balance and a second balance, in association with the identification information, the first balance indicating a balance of the first credit and a second balance indicating the balance of the second credit. Specifically, the storing section 120 is a readable/writable storage medium such as memory, a hard-disk, or an SSD (solid state drive) that stores, in association with the user, the first balance showing how much of the first credit can be used and the second balance showing how much of the second credit can be used.

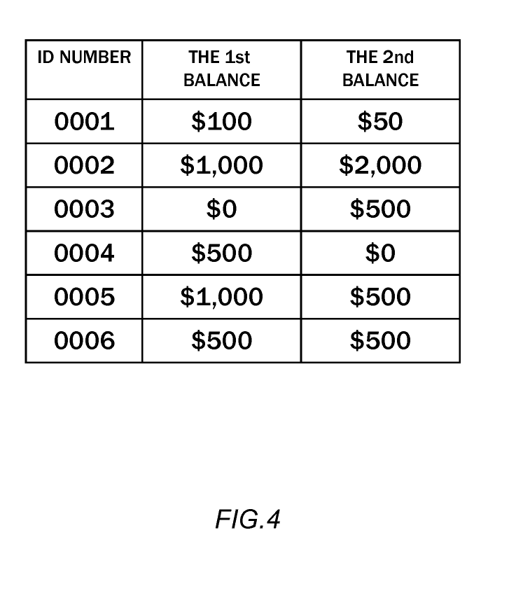

FIG. 4 shows the first example of identification information, the first balance, and the second balance stored in the storing section 120. The storing section 120 stores the first balance $100 and the second balance $50, in association with the identification information 0001, and stores the first balance $1000 and the second balance $2000, in association with the identification information 0002.

When a transaction request shows that the transaction is a payment transaction, the judging section 130 judges whether or not the transaction is allowed based on the result of comparing the transaction requesting amount with at least one of the first balance and the second balance, corresponding to the identification information that is included in the transaction request received by the request receiving section 110. For example, the judging section 130 judges whether or not the transaction is allowed based on at least one of (i) a result of comparing the first transaction requesting amount with the first balance corresponding to the identification information, and (ii) a result of comparing the second transaction request amount with the second balance corresponding to the identification information. Specifically, when the transaction requesting amount of the first credit contained in the transaction request is less than the first balance, the judging section 130 allows a use of the first credit. When the transaction requesting amount of the second credit that is contained in the transaction request is less than the second balance, the judging section 130 allows a use of the second credit.

When the transaction requesting amount of the first credit is larger than the first balance, the judging section 130 may allow a use of the money amount of up to the first balance. Similarly, when the transaction requesting amount of the second credit is larger than the second balance, the request receiving section 110 may allow a use of the money amount of up to the second balance.

When the transaction requesting amount is larger than the total balance, the judging section 130 may allow the transaction by allowing negative balances. For example, when a money amount that the transaction requesting amount exceeds the total balance is less than the predetermined amount, the judging section 130 allows the transaction.

When the judging section 130 judges that the transaction is allowed, the managing section 140 changes at least one of the first balance and the second balance stored in the storing section 120 based on the transaction requesting amount. For example, when the judging section 130 judges that a transaction is allowed, the managing section 140 changes at least one of (i) the first balance stored in the storing section 120 according to the first transaction requesting amount, and (ii) the second balance stored in the storing section 120 according to the second transaction requesting amount.

Specifically, when the transaction requesting amount of the first credit contained in the transaction request is less than the first balance, the managing section 140 changes remaining amount of money in the first balance by deducting the transaction requesting amount of the first credit from the first balance stored in the storing section 120. When the transaction requesting amount of the first credit contained in the transaction request is larger than the first balance, the managing section 140 may change the first balance that is stored in the storing section 120 to $0 or less.

Similarly, when the transaction requesting amount of the second credit that is contained in the transaction request is less than the second balance, the managing section 140 changes the remaining amount of money in the second balance by deducting the transaction requesting amount of the second credit from the second balance that is stored in the storing section 120. When the transaction requesting amount of the second credit that is contained in the transaction request is larger than the second balance, the managing section 140 may change the second balance stored in the storing section 120 to $0 or less. The managing section 140 may change both the first balance and the second balance simultaneously, and may change at least one of the first and second balances.

When the judging section 130 allows the transaction with a transaction requesting amount larger than the balance, the managing section 140 changes the balance to a negative value. For example, when the second balance is $50 and the transaction requesting amount is $80, the managing section 140 updates the second balance to be −$30.

When the transaction request shows that the transaction is a recharge transaction, the managing section 140 increases the first balance and the second balance that are stored, in association with the identification information, in the storing section 120. Specifically, the managing section 140 adds the first transaction requesting amount to the first balance stored in the storing section 120, adds the second transaction requesting amount to the second balance, and lets the storing section 120 store the updated first balance and the updated second balance.

The managing section 140 may store to the storing section 120, in association with the identification information, (i) the first balance of the first credit that may possibly be exchangeable to circulating money, and (ii) the second balance of the second credit that cannot be exchanged to circulating money. The managing section 140 may judge whether or not the first balance is exchangeable to circulating money based on the type of the source of the circulating money to be exchanged to the first credit. The managing section 140 may store to the storing section 120 the amount that can be exchanged to circulating money, corresponding to the type of source of the circulating money, such as cash or from a credit card, exchanged to the first credit.

When the request receiving section 110 receives the transaction request to exchange the first credit to circulating money, the managing section 140 judges whether or not exchanging to circulating money is allowed based on the transaction requesting amount and the first balance of the first credit that is exchangeable to circulating money. For example, when the balance of the first credit that was obtained by being exchanged from cash is more than the transaction requesting amount, the managing section 140 allows the first credit to be exchanged to circulating money. The managing section 140 does not allow the first credit obtained by using a credit card to be exchanged to circulating money. The managing section 140 may set the upper amount of exchanging the first credit obtained in a casino to circulating money.

[A Flowchart of the Operation for Judging the Possibility of a Transaction]

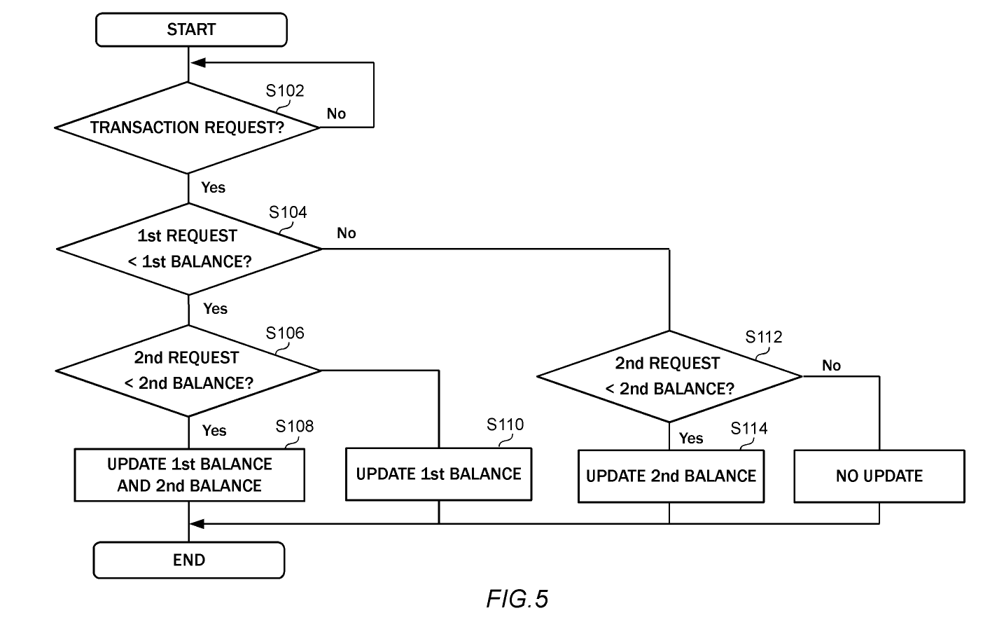

FIG. 5 shows a flowchart of an operation of the transaction management apparatus 100 in the present embodiment. When the transaction management apparatus 100 receives a transaction request, the transaction management apparatus 100 judges whether or not the first transaction requesting amount that is contained in the transaction request is less than or equal to the first balance stored in the storing section 120 (S102). When the first transaction requesting amount is less than the first balance (S104), the judging section 130 judges whether or not the second transaction requesting amount is less than or equal to the second balance (S106).

In the instance in which the second transaction requesting amount is also less than or equal to the second balance, the managing section 140 sends a notice of allowance for the transaction of the first credit and of the second credit to the transaction requesting apparatus 200, and updates the first balance and the second balance by deducting the first transaction requesting amount and the second transaction requesting amount from the first and second balances respectively (S108).

In the other instance in which the second transaction requesting amount is larger than the second balance, the managing section 140 sends a notice of allowance for the transaction from the first credit to the transaction requesting apparatus 200, and updates the first balance (S110). But the managing section 140 sends a notice of non-allowance for the transaction of the second credit to the transaction requesting apparatus 200, and does not update the second balance.

In this case, the transaction management apparatus 100 may then send the amount of the second balance to the transaction requesting apparatus 200. If the transaction management apparatus 100 then receives a request for using the second credit up to the second balance from the transaction requesting apparatus 200, the transaction management apparatus 100 may send a notice of allowance for the transaction of the second credit to the transaction requesting apparatus 200 and may update the second balance to $0.

When the first transaction requesting amount is larger than the first balance (S104), the judging section 130 judges whether or not the second transaction requesting amount is less than or equal to the second balance (S112). When the second transaction requesting amount is less than or equal to the second balance, the managing section 140 sends a notice of allowance for the transaction of the second credit to the transaction requesting apparatus 200 and updates the second balance (S114).

In this case, the transaction management apparatus 100 may then send the first balance to the transaction requesting apparatus 200. If the transaction management apparatus 100 then receives a request for using the first credit up to the first balance from the transaction requesting apparatus 200, the transaction management apparatus 100 may send a notice for allowance for the transaction of the first credit to the transaction requesting apparatus 200, and may update the first balance to $0.

When the transaction requesting amount is larger than the second balance, the managing section 140 deducts the value of the second balance in the transaction requesting amount, from the second balance, and deducts the difference between the transaction requesting amount and the second balance, from the first balance. That is, the managing section 140 maintains the largest balance possible in the first credit (as it has less limitations of use purpose than the second credit) by preferentially using the second credit and by only using the first credit when no usable second credit is left.

[Configuration of the Transaction Requesting Apparatus 200]

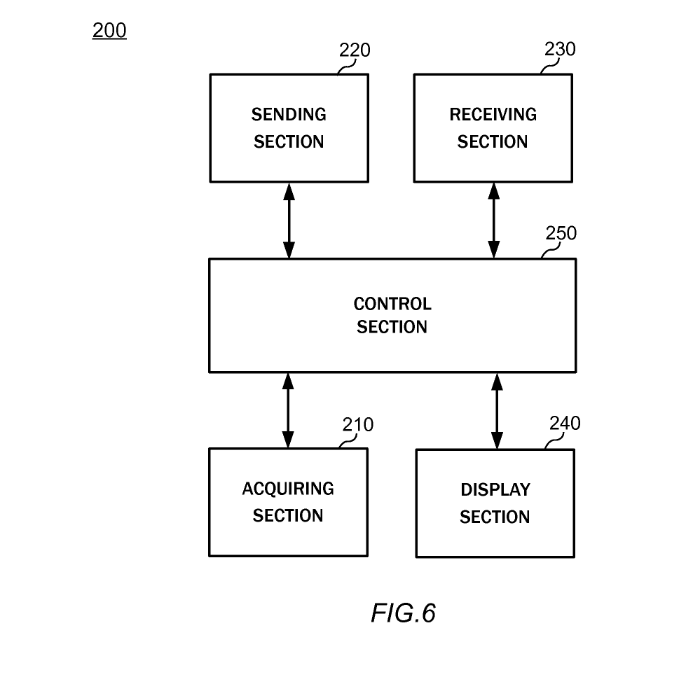

FIG. 6 shows the configuration of the transaction requesting apparatus 200 in the present embodiment. The transaction requesting apparatus 200 comprises an acquiring section 210, a sending section 220, a receiving section 230, a display section 240, and a control section 250. The control section 250 controls transferring the data between the acquiring section 210, the receiving section 230, and the display section 240.

The acquiring section 210 acquires the instruction regarding the transaction of local credits that can be used by a user. For example, the acquiring section 210 acquires identification information unique to a user, an instruction requesting a transaction, a transaction requesting amount or a use condition of the local credit. The acquiring section 210 has a near field communication interface, and may acquire identification information from a card with the NFC function. The acquiring section 210 may have a user interface section at which a user inputs transaction requesting amounts or use conditions of local credits.

Specifically, when the transaction requesting apparatus 200 is a slot machine, the acquiring section 210 acquires an amount that is expected to be used in the slot machine, an instruction to start a game at the slot machine, or an instruction to stop a game at the slot machine. When the transaction requesting apparatus 200 is an ATM, the acquiring section 210 may acquire an instruction to increase the local credit balance by paying cash. When the transaction requesting apparatus 200 is a POS terminal, the acquiring section 210 may acquire a purchased amount of the goods and a type of the goods.

The sending section 220 sends the request for a balance that requests the first balance indicating the balance of the first credit and the second balance indicating the balance of the second credit. This request is sent to the transaction management apparatus 100 that manages whether or not the first and second credit can be used in response to an instruction for the transaction that was acquired by the acquiring section 210. Specifically, if the transaction requesting apparatus 200 is a slot machine, after the acquiring section 210 acquires the identification information in response to the user placing the card that stores the identification information near the acquiring section 210, the sending section 220 sends the request for a balance to the transaction management apparatus 100.

The receiving section 230 receives the first balance and the second balance from the transaction management apparatus 100 through a network 50. When the first balance is $0, the receiving section 230 may receive only the second balance, and when the second balance is $0, the receiving section 230 may receive only the first balance.

The display section 240 displays the first balance and the second balance received by the receiving section 230. The display section 240 may display each of the first balance and the second balance, or may display the total balance that is a sum of the first balance and the second balance. The display section 240 may display that the first balance is the balance of the first credit that is exchangeable to circulating money, and may display that the second balance is the balance of the second credit that is not exchangeable to circulating money.

When the acquiring section 210 acquires from a user the instruction requesting a transaction, the sending section 220 sends a transaction request containing (i) a transaction requesting amount that shows the money amount requested in a transaction of at least one of the first credit and the second credit and (ii) the identification information of the user to the transaction management apparatus 100. The sending section 220 may send the transaction request after the sending section 220 sends the request for a balance, or may send the transaction request before the sending section 220 sends the request for a balance.

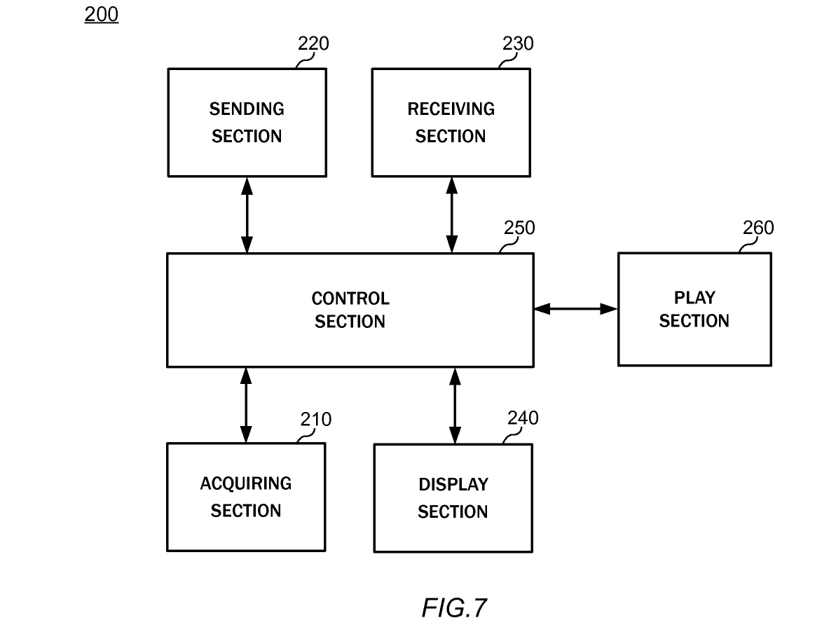

FIG. 7 shows another example of the transaction requesting apparatus 200 in the present embodiment. The transaction requesting apparatus 200 as shown in FIG. 7 is different from the transaction requesting apparatus 200 as shown in FIG. 6, as it comprises a play section 260. For example, the transaction requesting apparatus 200 of FIG. 7 may be a slot machine with which a user can play by using local credit. The play section 260 has a function to let a user play by using at least one of the first credit or the second credit.

Before the user begins to play, the acquiring section 210 acquires a play amount indicating an expected amount to be used in the play section 260. The acquiring section 210 may acquire the play amount after the display section 240 displays the first balance and the second balance. The acquiring section 210 may acquire the breakdown with the first credit and the second credit in the play amount.

The display section 240 may display a plurality of play amount options in a combination of a whole or part of the first balance, and a whole or part of the second balance. In a specific example, the display section 240 displays three options: the first play amount option of using $100 from the first balance, the second play amount option of using $50 from the first balance and $50 from the second balance, and the third play amount option of using $50 of the second balance. The display section 240 may display the play amount options received from the transaction management apparatus 100. The acquiring section 210 acquires the play amount from the option selected by the user from among the plurality of play amount options presented.

The acquiring section 210 may acquire the identification information and the play amount from a user's wireless information terminal 300. The wireless information terminal 300 may display a plurality of play amount options with a combination of the first balance and the second balance, and the acquiring section 210 may acquire the play amount option that is selected from among a plurality of the play amount options.

The sending section 220 sends the transaction request that includes the play amount as a transaction requesting amount to the transaction management apparatus 100. The sending section 220 may send the play amount of the first credit and the play amount of the second credit. The receiving section 230 receives, from the transaction management apparatus 100, (i) a first usable balance (corresponding to the identification information of the user) that can be used in the play and (ii) a second usable balance (also corresponding to the identification information of the user) that can be used in the play.

The transaction management apparatus 100 sends to the transaction requesting apparatus 200 the first balance and the second balance generated by a deduction of the transaction requesting amount from at least one of the first balance and the second balance. The balances are stored in the storing section 120, and the transaction request is sent to the transaction requesting apparatus 200 according to the transaction request.

The transaction management apparatus 100 sends the first usable balance and the second usable balance (that corresponds to the user's identification information) to the transaction requesting apparatus 200. The total amount of the first usable balance and the second usable balance is equal to the play amount that the acquiring section 210 acquired from the user.

The transaction management apparatus 100 may preferentially use the second balance when the transaction management apparatus 100 does not receive the breakdown of the first credit and the second credit in the play amount. For example, the transaction management apparatus 100 makes the second usable balance the same as the play amount when the play amount is less than or equal to the second balance, and reduces the first usable balance $0. The transaction management apparatus 100 may change the entire second balance to be the second usable balance, and make the second balance $0, and use the difference between the play amount and the second balance to reduce the first usable balance.

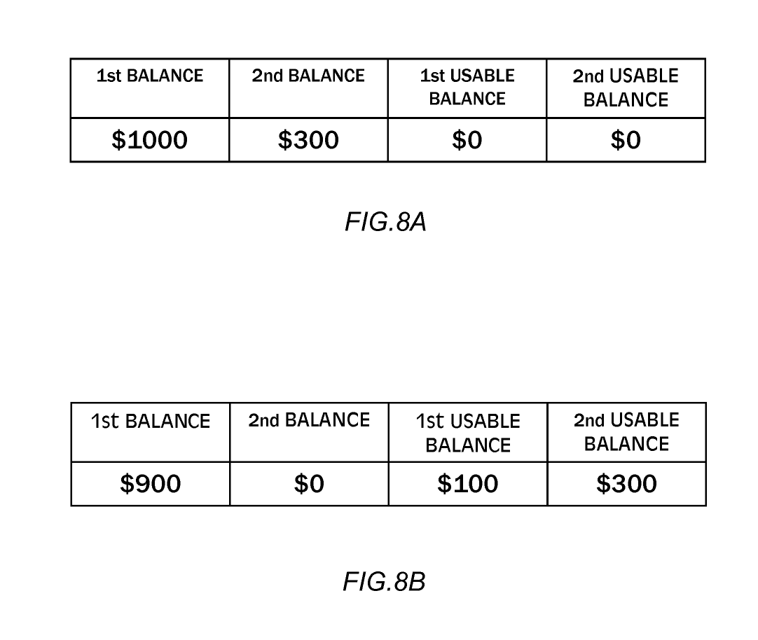

To further explain the relationship among the first balance, the second balance, the first usable balance, and the second usable balance, FIG. 8A and FIG. 8B show a specific example. In FIG. 8A, the first balance of the user is $1000, and the second balance is $300. The usable balances are both $0 because there is no balance available to the transaction requesting apparatus 200.

Suppose that a user wants to spend $400 in a play with a transaction requesting apparatus 200 that functions as a slot machine in this situation.

When the acquiring section 210 acquires the play amount $400 from the user, the sending section 220 sends a transaction request with the transaction requesting amount of $400 to the transaction management apparatus 100. Since the transaction requesting amount of $400 is smaller than the total amount of the first balance and the second balance, the judging section 130 allows the transaction.

Using the second balance preferentially, the managing section 140 judges that using $300 from the second balance and $100 from the first balance is preferable, and the managing section 140 updates the first balance to $900 by deducting $100 from the first balance in FIG. 8A, and updates the second balance to $0 by deducting $300 from the second balance in FIG. 8A, as shown in FIG. 8B. Also, the managing section 140 sets the first usable balance to $100 and the second usable balance to $300 that the user can use with the transaction requesting apparatus 200.

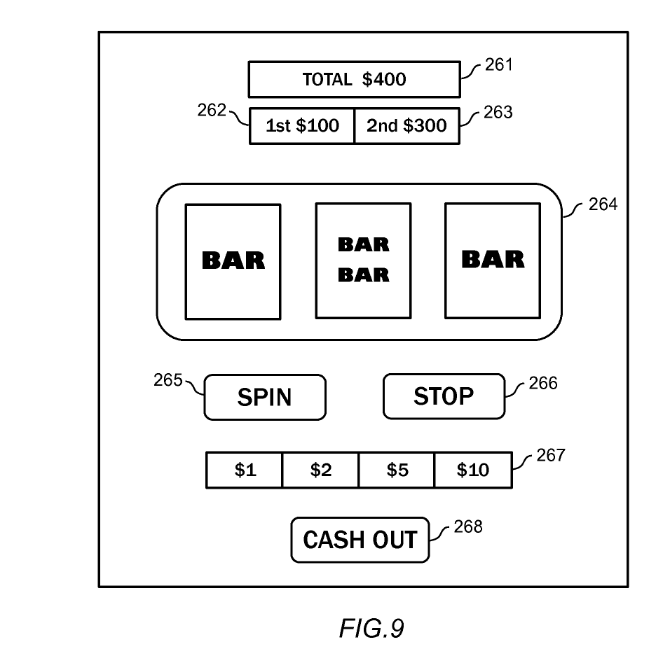

FIG. 9 shows an example of the display screen of the slot machine. In the display screen of FIG. 9, a usable balance 261, the first usable balance 262, the second usable balance 263, a rotating wheel 264, a spinning button 265, a stopping button 266, a bet selection button 267, and a “Cash out” button 268 are displayed.

The play section 260 (FIG. 7) increases or decreases at least one of the first usable balance and the second usable balance, according to the result of playing after receiving the instruction to begin play from the user. The play section 260 may carry out plays while a fee required for the play is less than or equal to a total amount of the first usable balance and the second usable balance.

Specifically, when the user selects the amount for a bet by using the betting selection button 267, and the user pushes the spinning button 265, the play section 260 rotationally displays various kinds of symbols in the rotating wheel 264. The play section 260 stops the rotational display of the rotating wheel 264 when the user pushes the stopping button 266. The play section 260 increases or decreases the user's usable balance according to the combination of a plurality of symbols at the timing of stopping the rotational display. For example, when the symbols with the same kind are displayed, the play section 260 increases the usable balance, and when symbols with the same kind are not displayed, the play section 260 decreases the usable balance.

The acquiring section 210 may acquire from the user the instruction whether the first usable balance is used or the second usable balance is used while the user is playing. The play section 260 may increase the first usable balance and the second usable balance with a different rate of return according to whether the first usable balance is used or the second usable balance is used. Here, the rate of return means the ratio of the obtained amount of money to the used amount of money.

While the first usable balance is a part of the balance of the first credit that the user purchased by using cash, the second usable balance is part of the balance of the second credit that a casino operating company distributed to the user for free. Therefore, the play section 260 may increase the rate of return when using the first usable balance in comparison to when using the second usable balance.

When the casino operating company intends to encourage the user that uses the second credit to use the slot machine, the play section 260 may increase the rate of return when using the second usable balance in comparison to when using the first usable balance.

Since the second credit is not able to be exchanged to circulating money, a common user tends to prefer using the second credit by leaving the remaining amount on the first credit as high as possible. Therefore, the play section 260 may preferentially use the second usable balance, and use the first usable balance after using up to the entire amount of the second usable balance. For example, when the second usable balance is available, the play section 260 decreases the second usable balance in the case of a “lose”. In the case of a “win,” the play section 260 increases the second usable balance.

The play section 260 may determine whether the first usable balance is increased or the second usable balance is increased according to the type of “win.” For a user, increasing the first usable balance is preferable. Therefore, the play section 260 may increase the first usable balance in the case of a “win” that occurs less frequently.

In the case of a “win,” the play section 260 may let the user select whether to increase the first usable balance by the first amount or to increase the second usable balance by the second amount that is larger than the first amount. A user becomes more excited because the user can select either increasing the first usable balance exchangeable to circulating money in a smaller amount or increasing the second usable balance un-exchangeable to circulating money in a larger amount.

When the user finishes the game, the acquiring section 210 acquires an instruction of ending the play from the user. For example, the acquiring section 210 acquires the instruction of ending by detecting that the user pushed the “Cash out” button 268.

When the acquiring section 210 acquires the instruction of ending play, the sending section 220 sends a transaction request that includes the first usable balance and the second usable balance to the transaction management apparatus 100. The sending section 220 may send the transaction request that includes information that shows whether there is to be a debit or a credit to the local credit. If the amount is to be debited to the local credit, the transaction to be requested is a payment transaction that decreases local credit. Or if the amount is to be credited to the local credit, the transaction to be requested is a recharge transaction that increases local credit.

The sending section 220 may send the transaction request that contains information indicating that the transaction is a recharge transaction when at least one of the first usable balance and the second usable balance shows a positive value. The sending section 220 may show that the request is a recharge transaction by sending the transaction requesting amount with a minus sign or by sending the transaction requesting amount with another specified designation.

In the transaction management apparatus 100 that received the transaction request, the managing section 140 (FIG. 3) adds the first usable balance to the first balance, and adds the second usable balance to the second balance that are both read out from the storing section 120. The managing section 140 stores the first balance and the second balance after the addition to the storing section 120, and sends the calculated figure to the transaction requesting apparatus 200.

In the transaction requesting apparatus 200, the receiving section 230 (FIGS. 6, 7) receives the first balance and the second balance sent from the managing section 140, and the display section 240 displays the first balance and the second balance updated at the transaction management apparatus 100 after the acquiring section 210 acquired the instruction to end play.

[A Communication Sequence of Playing a Game in a Transaction Requesting Apparatus 200 that Functions as a Slot Machine]

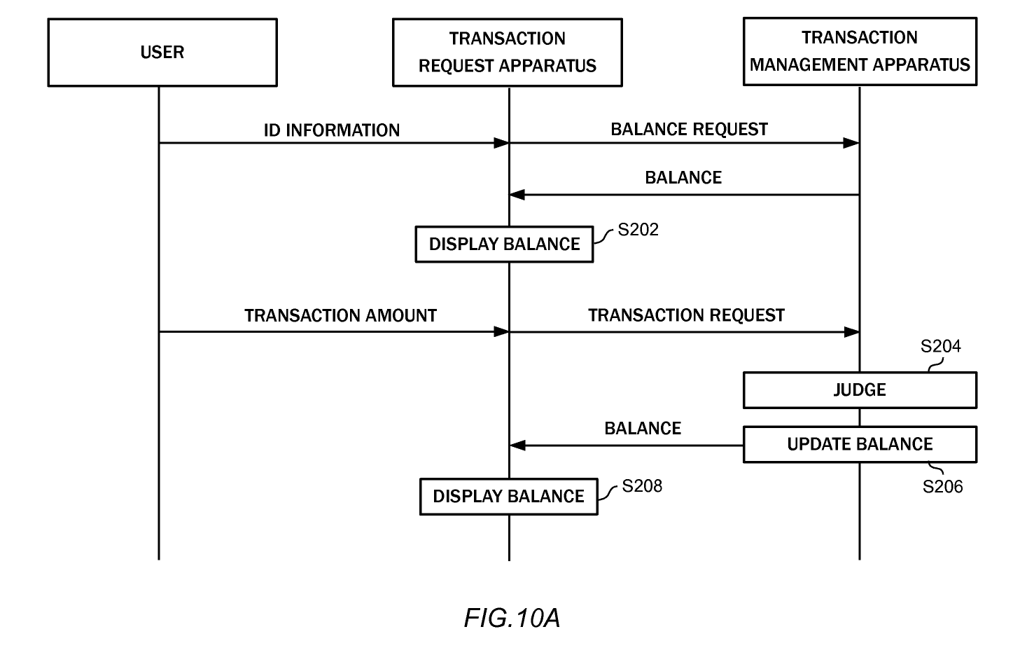

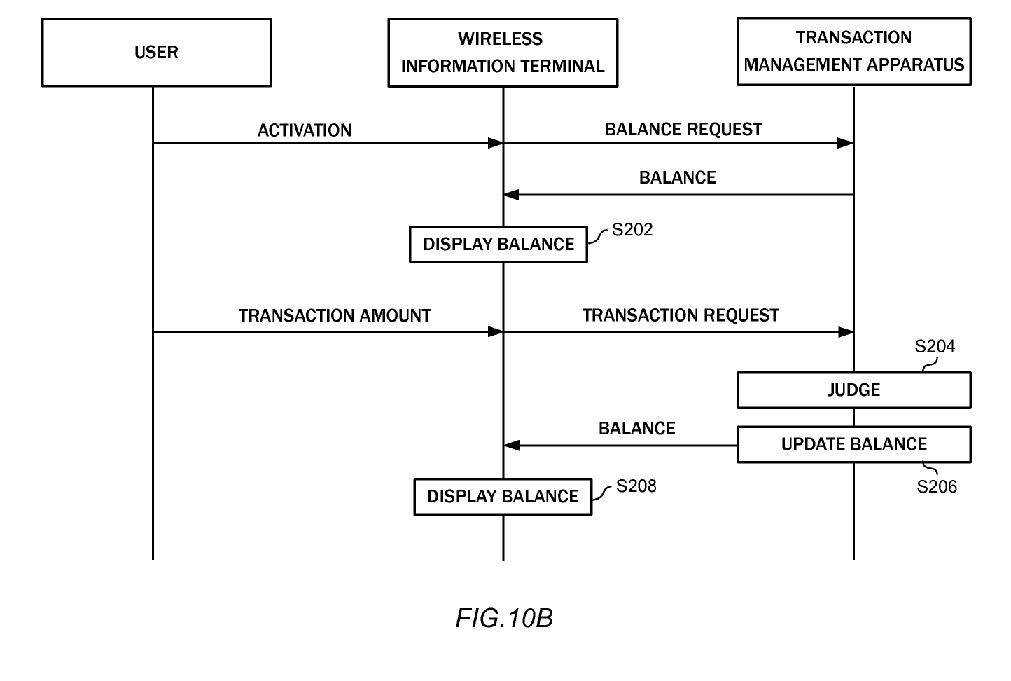

FIG. 10A shows an example of a communication sequence in the transaction management system 10 according to the present embodiment. The transaction requesting apparatus 200 in the present embodiment functions as a slot machine. A user plays at the transaction requesting apparatus 200 that functions as a slot machine by using the first credit or the second credit.

When the user brings a card that stores unique identification information close to the transaction requesting apparatus 200, the acquiring section 210 acquires the identification information. For example, a user may obtain a card that stores the identification information by paying cash when entering a hotel or a casino. The sending section 220 sends the transaction management apparatus 100 a balance request to confirm the local credit balance of the user corresponding to the identification information.

In the transaction management apparatus 100, when the request receiving section 110 receives the balance request, the managing section 140 reads out each of the first balance and the second balance figures that corresponds to the identification information from the storing section 120, and sends the information to the transaction requesting apparatus 200. In the transaction requesting apparatus 200, the display section 240 displays the first balance and the second balance that were received by the receiving section 230 (S202).

Next, the acquiring section 210 acquires the play amount that a user intends to spend in a play at a slot machine. The acquiring section 210 may acquire the first play amount for playing by using the first credit and the second play amount for playing by using the second credit. The sending section 220 sends a transaction request containing the identification information of the user and the play amount that was acquired by the acquiring section 210.

In the transaction management apparatus 100, the judging section 130 judges whether or not a transaction request is allowed by comparing the transaction requesting amount with the first balance and the second balance that are stored corresponding to the identification information (S204). After carrying out the transaction based on the result of a judgment by the judging section 130, the managing section 140 stores the first balance and the second balance to the storing section 120 (S206). Further, the managing section 140 sends a notice of allowance for a transaction containing the first balance, the second balance, the first usable balance, and the second usable balance after carrying out the transaction to the transaction requesting apparatus 200.

In the transaction requesting apparatus 200, the display section 240 displays the first usable balance and the second usable balance (S208). Optionally, the display section 240 may also display the first balance and the second balance. When the judging section 130 does not allow the transaction, the managing section 140 notifies the transaction requesting apparatus 200 not to allow a transaction.

[A Communication Sequence of a Transaction by the Wireless Information Terminal 300 that Functions as the Transaction Requesting Apparatus 200]

FIG. 10B shows another example of a communication sequence in the transaction management system 10 of the present embodiment. The wireless information terminal 300 in the present embodiment functions as a transaction requesting apparatus 200. A user can recharge the first credit or the second credit and make payments by using the first credit or the second credit by using the wireless information terminal 300.

When the user activates application software for recharging or making a payment in the transaction management system 10, the wireless information terminal 300 sends a balance request containing the user's identification information that has been stored, to the transaction management apparatus 100.

In the transaction management apparatus 100, when the request receiving section 110 receives a balance request, the managing section 140 reads out the first balance and the second balance corresponding to the identification information from the storing section 120, and sends the information to the wireless information terminal 300. In the wireless information terminal 300, the display section 240 displays the first balance and the second balance that are received by the receiving section 230 (S202).

Next, the acquiring section 210 in the wireless information terminal 300 acquires the amount that a user recharges or spends on a payment. The sending section 220 sends a transaction request containing identification information of the user and the transaction requesting amount corresponding to the recharging amount or the payment amount that is acquired by the acquiring section 210 to the transaction management apparatus 100. The following processes are the same as the process that is described in connection with FIGS. 10A and 10B.

[A Sequence of Playing a Game in the Transaction Requesting Apparatus 200 by Using the User's Wireless Information Terminal]

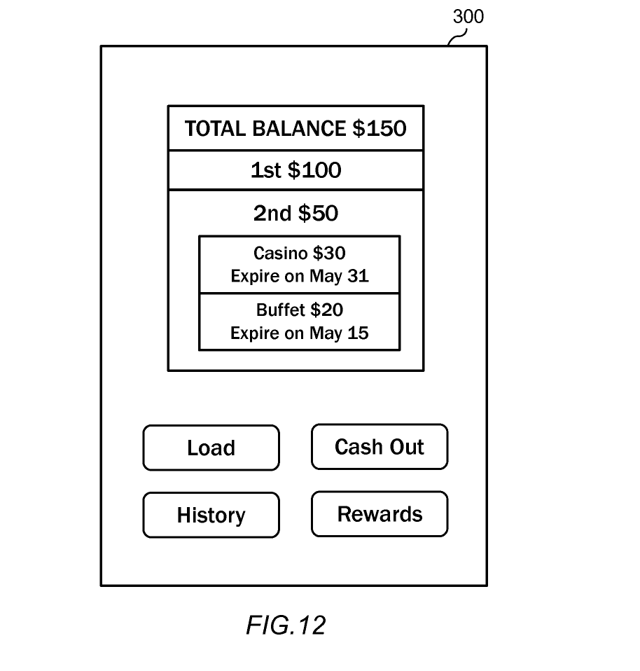

FIG. 11 shows another example of a communication sequence in the transaction management system 10 of the present embodiment. According to the communication sequence shown in FIG. 11, a user carries out a transaction by using the wireless information terminal 300. FIG. 12 shows an example of the display of the wireless information terminal 300. For example, by using the wireless information terminal 300, the user plays a game with the transaction requesting apparatus 200 after transferring part of the local credit to the transaction requesting apparatus 200 that functions as a slot machine.

First, the user activates the application software for carrying out the transaction by operating the wireless information terminal 300. When the application software is activated in the wireless information terminal 300, the wireless information terminal 300 sends the balance request containing the identification information of the user to the transaction management apparatus 100. When the transaction management apparatus 100 receives the balance request, the transaction management apparatus 100 sends the first balance and the second balance corresponding to the identification information to the wireless information terminal 300. The wireless information terminal 300 displays the received first balance and the received second balance (S302). In FIG. 12, for example, the first balance of $100, the second balance of $50, and the total amount of the balance of $150 are displayed.

Next, when the user pushes the button “Load,” the wireless information terminal 300 displays a screen for inputting the local credit amount (the play amount) to be transferred to the transaction requesting apparatus 200. The wireless information terminal 300 may display a plurality of play amount options that are with a combination of the first balance and the second balance. For example, the wireless information terminal 300 displays the first play amount option to use $100 out of the first balance, the second play amount option to use $50 out of the first balance and $50 out of the second balance, and the third play amount option to use $50 out of the second balance. Optionally, the software application can allow the user to directly input the amounts used out of each of the first and second balances, up to the total available.

When the user selects or inputs the local credit amount that is transferred to the transaction requesting apparatus 200 in the wireless information terminal 300, and then brings the wireless information terminal 300 close to the transaction requesting apparatus 200, the acquiring section 210 acquires the identification information of the user and the aforementioned play amount from the wireless information terminal 300 through NFC. The sending section 220 sends the transaction request that contains (i) the received identification information and (ii) the transaction requesting amount corresponding to the play amount, to the transaction management apparatus 100.

In the transaction management apparatus 100 that received the transaction request, when the judging section 130 allows the transaction, the managing section 140 updates the first balance and the second balance by deducting the requested transaction amount from at least one of the first balance and the second balance that are stored in the storing section 120 (S304).

Next, the managing section 140 sends the notice of allowance containing the first balance, the second balance, the first usable balance and the second usable balance to the transaction requesting apparatus 200. In the transaction requesting apparatus 200, when the receiving section 230 receives the notice of allowance for the transaction, the display section 240 displays the usable balance corresponding to the transaction requesting amount (S306). The display section 240 may display the first usable balance that can be used for play using the first credit and the second usable balance that can be used for play using the second credit. Further, the display section 240 may display the first balance and the second balance. At this time, the user can start a game in the transaction requesting apparatus 200.

The transaction requesting apparatus 200 sends the first balance and the second balance to the wireless information terminal 300. The wireless information terminal 300 may display the received first balance and the received second balance (S308). Herein, the total amount of the first balance and the second balance that is displayed by the wireless information terminal 300 is the amount generated by deducting the total amount of the first usable balance and the second usable balance from the total amount of the first balance and the second balance that were displayed in S302.

When the user ends the game in the transaction requesting apparatus 200, the user pushes the “Cash out” button located in the transaction requesting apparatus 200. When the acquiring section 210 acquires the instruction to end the game through the “Cash out” button, the sending section 220 sends the transaction request containing at least one of the first usable balance and the second usable balance as the transaction requesting amount to the transaction management apparatus 100.

When the managing section 140 receives the transaction request containing the first usable balance and the second usable balance, the managing section 140 reads out the first balance and the second balance from the storing section 120. Next, the managing section 140 adds the amounts corresponding to the first play amount and the second play amount, both contained by the transaction request, to the first balance and the second balance. These are then stored in the storing section 120 (S310).

The managing section 140 sends the updated first balance and the updated second balance to the transaction requesting apparatus 200, and the display section 240 displays the updated first balance and the updated second balance (S312). The transaction requesting apparatus 200 sends the updated first balance and the updated second balance, received from the transaction management apparatus 100, to the wireless information terminal 300. The wireless information terminal 300 may display the updated first balance and the updated second balance (S314).

Here, the total amount of the first balance and the second balance that the wireless information terminal 300 displays is smaller than the total amount that was displayed in S302 by the amount used by the user in the transaction requesting apparatus 200, and is larger than the total amount that was displayed in S308 by the total amount of the first play balance and the second play balance.

When the wireless information terminal 300 acquires the transferred local credit amount from the user after displaying the first balance and the second balance in S302, the wireless information terminal 300 may send the transaction request containing the transfer amount as the transaction requesting amount to the transaction management apparatus 100, instead of sending the transfer amount to the transaction requesting apparatus 200. For example, the wireless information terminal 300 acquires the apparatus identification information of the transaction requesting apparatus 200 from the transaction requesting apparatus 200, and sends the transaction requesting amount and the apparatus identification information of the transfer destination to the transaction management apparatus 100.

[A Sequence of Playing a Game with the Transaction Requesting Apparatus 200 by Using an Information Storage Card]

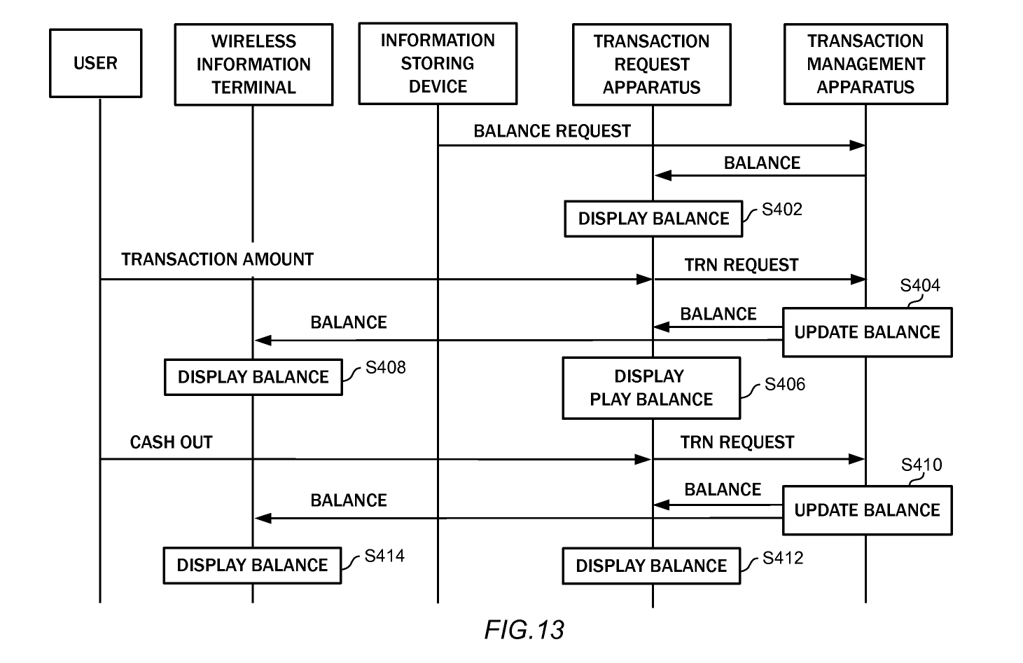

FIG. 13 shows another example of the communication sequence in the transaction management system 10 of the present embodiment. According to the communication sequence as shown in FIG. 13, the user plays a game with the transaction requesting apparatus 200 by using the information storage card that stores the identification information.

First, the user brings the information storage card close to the transaction requesting apparatus 200. The information storage card is, for example, a magnetic card, an NFC card (Near Field Communication Card) or an IC card (Integrated Circuit Card).

When the acquiring section 210 acquires the user's identification information that is stored in the information storage card, the sending section 220 sends the balance request containing the identification information to the transaction management apparatus 100. After receiving the balance request, the transaction management apparatus 100 sends the first balance and the second balance corresponding to the identification information to the transaction requesting apparatus 200. The transaction requesting apparatus 200 displays the received first balance and the received second balance (S402).

Next, the user inputs the amount of money to play (the play amount) by using the operating display of the transaction requesting apparatus 200 after seeing the first balance and the second balance displayed on the transaction requesting apparatus 200. When the transaction requesting apparatus 200 acquires the play amount from the user, the transaction requesting apparatus 200 sends the transaction request containing the play amount to the transaction management apparatus 100.

The managing section 140 updates the first balance and the second balance that are stored in the storing section 120 by deducting the play amount from the first balance and the second balance (S404). The updated first balance, the updated second balance, the updated first usable balance, and the updated second usable balance are then sent to the transaction requesting apparatus 200. The managing section 140 may send an e-mail containing the first balance and the second balance to the wireless information terminal 300 of the user that was stored in advance in association with the identification information.

Next, the display section 240 displays the first usable balance and the second usable balance (S406). The wireless information terminal 300 may display the first balance and the second balance that are received from the transaction management apparatus 100 (S408).

When the user ends a play in the transaction requesting apparatus 200, the user pushes the “Cash out” button located in the transaction requesting apparatus 200. The rest of the communication sequence is the same as the communication sequence as shown in FIG. 11.

[Calculating the Balance for Each Use Condition of Second Credit]

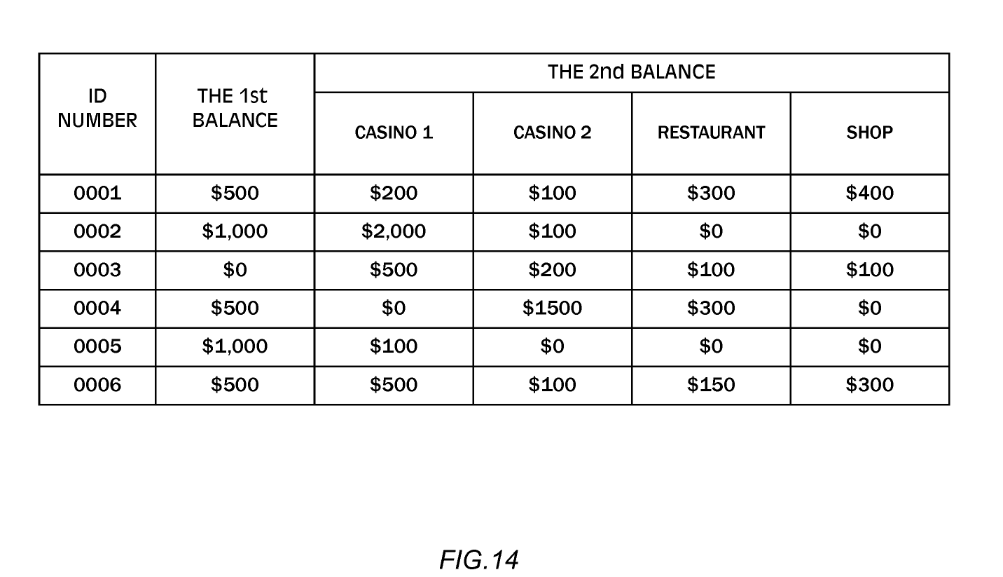

FIG. 14 shows the second example of identification information that is stored in the storing section 120, the first balance, and the second balance. As shown in FIG. 14, the managing section 140 may store at least a second balance matching the use condition of the second credit.

In FIG. 14, the second balance is set according to the use conditions of the second credit. For example, in FIG. 14, the storing section 120 stores, in association with the identification information 0001, the following amount of the second balance $200 for the casino 1; $100 for the casino 2; $300 for the restaurant; and $400 for the shop. The user can use the second credit that is stored corresponding to the identification information 0001 up to the second balance matching each of the use conditions. For example, the user of the identification information 0001 can use up to $300 at the restaurant, and can use up to $200 at casino 1 out of the total amount $1000 on the second credit.

As described above, when the transaction management apparatus 100 manages the second balance matching the use condition, the user is able to confirm the balance matching the use condition. In the transaction requesting apparatus 200, when the acquiring section 210 acquires the instructions from the user to confirm the balance, the sending section 220 sends the balance request containing the information that indicates the use condition of the first credit and the second credit to the transaction management apparatus 100. The display section 240 may display a plurality of use conditions. The acquiring section 210 may acquire a use condition that the user selected among a plurality of use conditions that are displayed in the transaction requesting apparatus 200, and the sending section 220 may send the balance request containing the information indicating the selected use condition.

When the transaction management apparatus 100 receives the balance request, the managing section 140 reads out the first balance and the second balance matching the use condition stored in the storing section 120, and sends them to the transaction requesting apparatus 200.

The receiving section 230 receives the first balance and the second balance that can be used under the use condition sent by the sending section 220 from the transaction management apparatus 100, corresponding to the user's identification information. The display section 240 displays at least one of the first balance and the second balance that can be used under the use condition. The display section 240 may display the total amount of a plurality of second balance amounts that can be used under the use condition that was contained in the balance request that was sent.

The transaction requesting apparatus 200 may extract and display at least one of the first balance and the second balance matching the use condition under which the user intends to use local credit from the first balance and the second balance, corresponding to the identification information of the user who uses the transaction requesting apparatus 200. The displayed balance is based on information that was received in advance from the transaction management apparatus 100. For example, the transaction requesting apparatus 200 acquires in advance the first balance and the second balance matching all the use conditions. When the transaction requesting apparatus 200 acquires the use condition of local credit from the user, the transaction requesting apparatus 200 displays the first balance and the second balance matching the acquired use condition.

When the user wants to purchase goods or services, the sending section 220 sends the transaction request containing the information indicating the use condition of the first credit and the second credit to the transaction management apparatus 100. The request receiving section 110 receives the transaction request containing the use condition of the second credit and the transaction requesting amount matching the use condition. For example, when the user wants to use $100 of the second credit in order to play at a slot machine in casino 1, the sending section 220 sends the transaction request that contains the information indicating that the use condition corresponds to a play in casino 1 to the transaction management apparatus 100, and that the transaction requesting amount is $100.

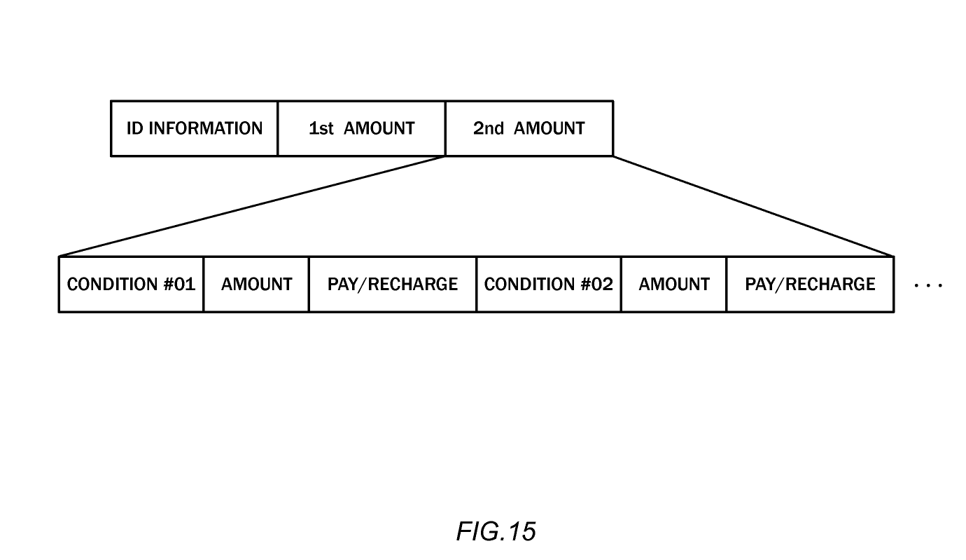

FIG. 15 shows an example of the transaction request that is sent by the sending section 220. The sending section 220 may send a transaction requesting packet containing the identification information, the transaction requesting amount, and the use condition. In FIG. 15, the transaction requesting packet contains the identification information field, the first transaction requesting amount field, and the second transaction requesting amount field.

The second transaction requesting amount fields includes sub-fields that each indicates the transaction requesting amount for each use condition. Specifically, the second transaction requesting amount field has the use condition sub-field that contains information indicating the first use condition, the transaction requesting amount sub-field under that use condition, and the transaction type sub-field indicating whether the second credit is used for payment or for recharging.

The sending section 220 may assign code that corresponds to the use conditions to the use condition sub-field. For example, when the use condition is a slot machine of casino 1, the sending section 220 inputs 01 to the use condition sub-field, and when the use condition is for supper at a restaurant, the sending section 220 inputs 03 to the use condition sub-field. The transaction management system 10 is able to manage the second credit for each use condition by the transaction requesting apparatus 200 and the transaction management apparatus 100 by storing the use condition code corresponding to each set of conditions.

The judging section 130 judges whether or not the transaction is allowed after comparing the transaction requesting amount matching the use condition contained in the transaction request with at least one of the second balances matching that use condition. Specifically, when the transaction requesting amount contained in the transaction request is less than or equal to the second balance matching the use condition contained in the transaction request, the judging section 130 allows the transaction.

When the transaction requesting amount contained in the transaction request is larger than the second balance that can be used under the use condition contained in the transaction request, the judging section 130 prohibits the transaction. When the judging section 130 allows the transaction, the managing section 140 deducts the requested transaction requesting from the second balance matching the use conditions allowed by the judging section 130, and stores the deducted second balance to the storing section 120.

For example, when the transaction requesting amount that the request receiving section 110 received with the use condition of a use at a slot machine is $100, and the second balance that can be used at the casino is $200, the judging section 130 allows the user to spend $100 at a slot machine. The managing section 140 updates the second balance stored in the storing section 120, corresponding to the casino by deducting to $100 from $200.

As mentioned above, by the transaction management apparatus 100 managing the second balance for each use condition of second credit, the company that introduced the transaction management system 10 is able to utilize the transaction management system 10 as a means for sales promotion to users. For example, the company that introduced the transaction management system 10 is able to effectively promote sales of the goods or services by issuing the second credits that have different use conditions for each user, or by issuing second credits with different use conditions for different time periods.

When the managing section 140 updates at least one of the first balance and the second balance according to the transaction request containing the first use conditions received by the request receiving section 110, the managing section 140 may increase the second balance matching the second use condition corresponding to the first use condition according to an adding amount corresponding to the first use condition. For example, when a user uses $100 at a restaurant, the managing section 140 increases the second balance of the second credit that can be used at the casino by a predetermined ratio of the amount of the first credit (for example $10). When the user uses the second credit more than a predetermined amount (for example, more than $200) at a jewelry shop, the managing section 140 may increase the second balance of the second credit that can be used at the casino and the second credit that can be used at the restaurant by a predetermined amount respectively.

As described above, when local credit is used, the company that uses the transaction management system 10 is able to advantageously use a part of the profits obtained from a user for a promotion of other services by increasing the second balance matching the use conditions that are different from the use conditions under which the local credit was used. The managing section 140 may increase the second balance by different ratios of the used amount between using the first credit and using the second credit.

When at least one of the first balance and the second balance are within a range of a predetermined amount after managing section 140 changes at least one of the first balance and the second balance, the managing section 140 may increase the second balance according to an adding amount corresponding to the first balance and the second balance. For example, the company using the transaction management system 10 is able to motivate users to increase the first balance by issuing second credit to the user when the first balance is more than a predetermined amount.

When the transaction requesting amount matching the use condition contained in the transaction request is larger than the second balance matching the use condition, the managing section 140 may deduct the same amount as the second balance from the second balance matching the use condition of the transaction requesting amount (i.e., the second balance is reduced to $0), and the managing section 140 may deduct the difference in amount between the transaction requesting amount matching the use condition and the second balance matching the use condition from the first balance (i.e., the remaining balance is deducted from the first balance). As an example, when the storing section 120 stores the second balance matching the use condition contained in the transaction request, the managing section 140 may deduct the transaction requesting amount from the second balance, and when the storing section 120 does not have stored a second balance matching the use condition, the managing section 140 may deduct the transaction requesting amount from the first balance.

Specifically, when the managing section 140 receives the transaction request with the use condition of “use at a restaurant,” the managing section 140 allows the transaction of second credit if the transaction requesting amount is less than or equal to the second balance matching the use condition of “use at a restaurant.” When the transaction requesting amount (for example, $100) is larger than the second balance that can be used at a restaurant (for example, $60), the managing section 140 reduces the second balance that can be used at a restaurant to $0, and deducts the difference ($40) between the transaction requesting amount ($100) and the used second balance ($60) from the first balance.

When a user corresponding to the identification information contained in the transaction request does not have second credit for buying clothes in spite of receiving a transaction request that the use condition is “a purchase of clothes,” the managing section 140 carries out the transaction using first credit. When the managing section 140 updates the first balance and the second balance, the managing section 140 sends a notice of allowance for the transaction to the transaction requesting apparatus 200. Therefore, though the user is able to preferentially use the second credit by the managing section 140 carrying out the transaction as described above, if no second credit is available matching the use condition, the first balance is used.

Thus, the transaction management apparatus 100 may determine whether first credit should be used or second credit should be used based on the use condition contained in the transaction request that was received from the transaction requesting apparatus 200.

Specifically, the request receiving section 110 receives the transaction request containing the use conditions of second credit. The judging section 130 judges (i) whether or not both the first credit and the second credit should be used or (ii) which portions of the first credit and the second credit should be used according to at least one of the use conditions contained in the transaction request. One of the first balance and the second balance selected based on a result of the judgment made by the judging section 130 is changed according to the transaction requesting amount.

For example, the judging section 130 reads out the second balance matching the use condition from the storing section 120. When the second balance matching the use condition contained in the transaction request is not $0, the judging section 130 judges that second credit should be used preferentially to first credit. When the second balance matching the use condition is $0, the judging section 130 judges that first credit should be used. Also, the judging section 130 may carry out (i) the judgment whether first credit should be used or second credit should be used and (ii) the judgment whether the transaction should or should not be allowed by using different computers for each judgment.

As described above, the user or the transaction requesting apparatus 200 is not required to judge whether the first credit should be used or the second credit should be used for each use condition, since the transaction management apparatus 100 judges the type of local credit to be used based on the use conditions.

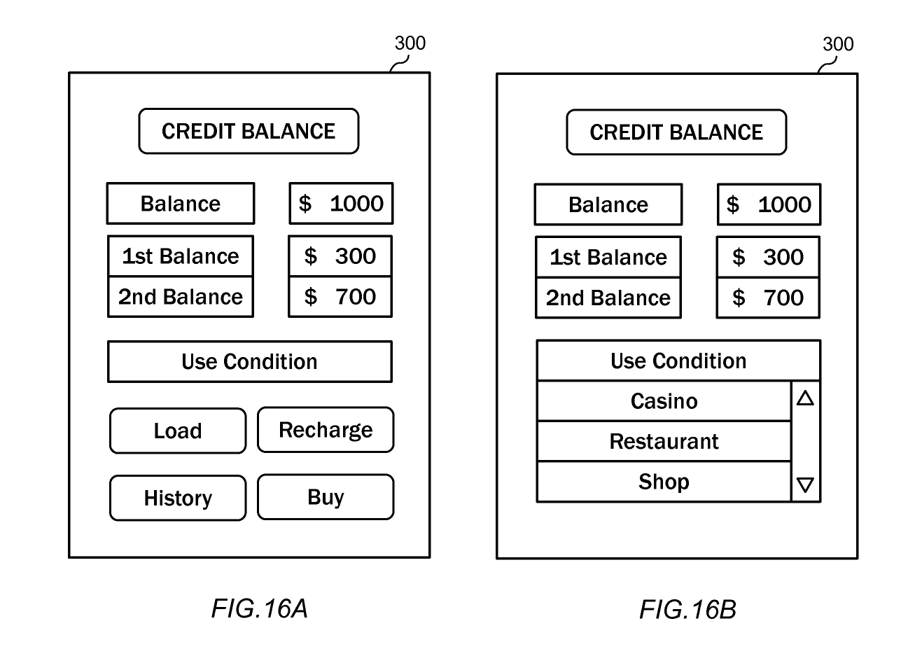

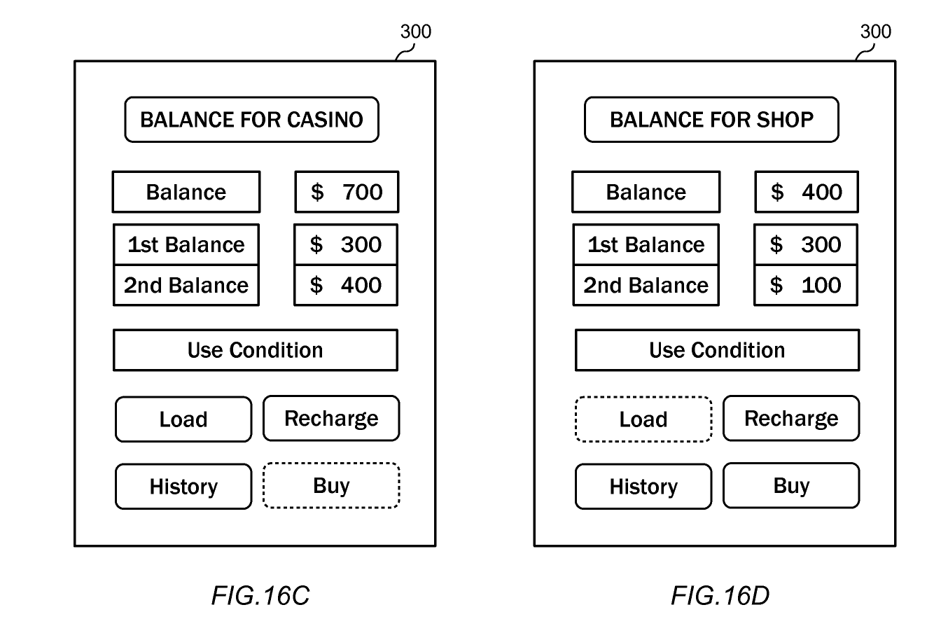

FIGS. 16A to 16D show the displays of the wireless information terminal 300 that display the balance matching the use conditions. FIG. 16A is different from the display screen that is shown in FIG. 2, in that it displays the “Use Condition” button for selecting the use condition of local credit. When a user pushes the “Use Condition” button, the wireless information terminal 300 displays the screen for selecting the use conditions as shown in FIG. 16B. In FIG. 16B, the wireless information terminal 300 displays “Casino,” “Restaurant,” and “Shop” as use conditions. The wireless information terminal 300 may display other use conditions according to a user's operations.

FIG. 16C shows the display screen when the user selects the “Casino” use condition. The wireless information terminal 300 displays the balance of local credit that can be used at the casino. Specifically, the second credit that can be used at the casino is $400 and the first credit is $300. Therefore the total amount that can be used at the casino is $700. The user is able to transfer an amount of up to $700 to the transaction requesting apparatus 200 that functions as a slot machine by pushing the “Load” button. The wireless information terminal 300 may make the “Buy” button not operational while displaying the balance that can be used at the casino.

FIG. 16D shows the display screen when the user selects the “Shop” use condition. Since the second credit that can be used at a shop is $100, the wireless information terminal 300 displays the total balance amount of $400. The wireless information terminal 300 may display the goods that can be bought at the shop.

[Limiting the Effective Period of Second Credit]

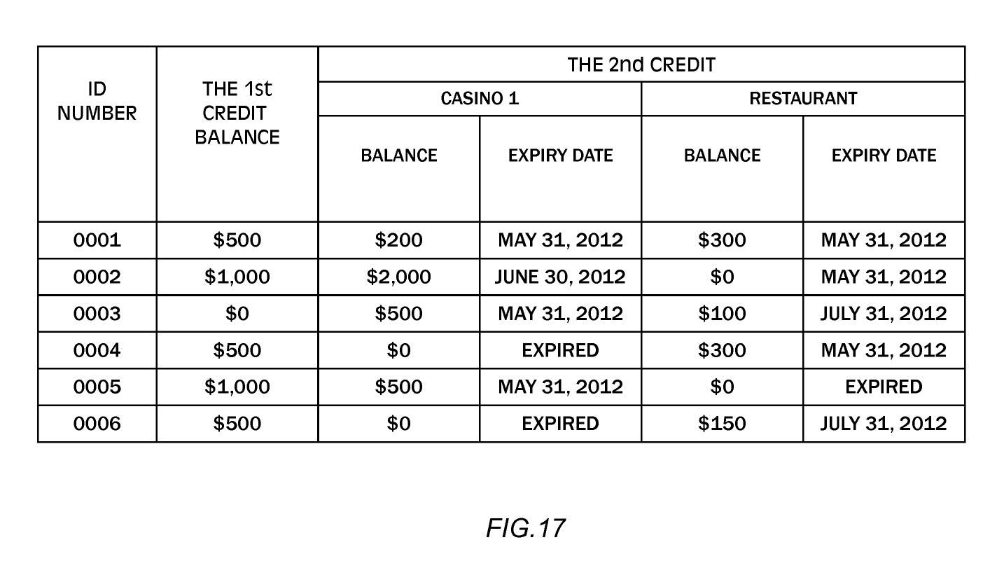

FIG. 17 shows the third example of the identification information, the first balance and the second balance that are stored by the storing section 120. The managing section 140 may store, as one of the use conditions, the effective period indicating the term during which the second credit can be used to the storing section 120, in association with the identification information. The managing section 140 may store the effective period for each use condition to the storing section 120, in association with the identification information.

As an example, in FIG. 17, the storing section 120 stores the end date of the effective period predetermined for each use condition of second credit. Specifically, FIG. 17 shows that the amount of second credit that the user of the identification information 0001 can use at Casino 1 is $200, and that the effective period expires on May 31, 2012. The managing section 140 may store the start date and the end date of the effective period to the storing section 120.

When the storing section 120 stores the effective period of the second credit, the judging section 130 additionally judges whether or not the transaction is allowed based on whether or not the time and date of receiving the transaction request is included in the effective period. For example, the request receiving section 110 receives the use condition that shows the usage of the second credit and the transaction request containing the transaction requesting amount matching that use condition. The judging section 130 may judge whether or not the transaction is allowed at least based on the time of receiving the transaction request, the use condition that is contained in the transaction request, and the effective period matching the use condition.

Specifically, when the time and date of receiving the transaction request is included in the effective period, the judging section 130 allows the transaction from the second credit. When the time and date of receiving the transaction request is not included in the effective period, the judging section 130 does not allow the transaction from the second credit. When the time and date of receiving the transaction request is not included in the effective period, and the transaction requesting amount is less than or equal to the first balance of the first credit, the judging section 130 may allow the transaction using the first credit.

The managing section 140 may change the second balance of the second credit with an expired effective period to $0. The managing section 140 may notify the transaction requesting apparatus 200 that the effective period has ended at the end time of the effective period of the second credit.

As described above, this has the effect that the company that issues second credit is able to strategically issue it in accordance with the sales planning of goods or services by setting effective periods of second credit with the transaction management system 10.

[Enabling the Use of a Combination of a Plurality of Second Credits with Different Use Conditions]

The transaction management system 10 may let the user use a plurality of second credits with different use conditions, in different combinations. That is to say, when the user purchases goods or services by using second credit with the transaction requesting apparatus 200, the user is able to use a plurality of second credits that can be used for the purchase of those goods or services in combination.

Specifically, when the acquiring section 210 in the transaction requesting apparatus 200 acquires an instruction from the user to purchase goods, the sending section 220 sends the transaction request containing the name of the goods and the price to the transaction management apparatus 100. The judging section 130 allows the transaction when the requested transaction amount is less than the total amount of a plurality of second balances matching the use conditions contained in the transaction request.

For example, when the user wants to use second credit for a meal at a restaurant in the casino, the judging section 130 allows the transaction if the amount to be used is within range of the total amount of the second balance of the second credit that can be used “anywhere in a casino” and the second balance of second credit that can be used “in a restaurant”. Specifically, when the second balance of second credit that can be used at a casino is $200 and the second balance of second credit that can be used at a restaurant in a casino is $300, the user is able to use up to $500 of second credit in the restaurant of the casino.

When the judging section 130 allows the transaction, the managing section 140 deducts the transaction requesting amount from a plurality of second balances. Specifically, the managing section 140 deducts from a plurality of second balances so that the total amount of the deductions from a plurality of second balances matches the transaction requesting amount.

When the transaction requesting amount is within the second balance for either of the use conditions, the managing section 140 may deduct the transaction requesting amount only from the second balance that is larger than the transaction requesting amount. When the transaction requesting amount is larger than the second balance for either of the use conditions, the managing section 140 may make the second balance for any one of the use conditions $0, and may deduct the difference between the transaction requesting amount and the second balance for the first use condition from the second balance with other use conditions.

In the transaction requesting apparatus 200, when the receiving section 230 receives a plurality of second balances from the managing section 140, the display section 240 may display the total amount of a plurality of second balances that can be used under the use conditions selected by the user. For example, when the second balance corresponding to a casino is $200 and the second balance corresponding to a restaurant is $300, the display section 240 displays that up to $500 can be used at a restaurant in a casino. The wireless information terminal 300 may display the total amount of a plurality of second balances that can be used under the use conditions selected by the user.

The use conditions are not restricted to the goods or location for which second credit is used. For example, suppose that the user has one type of second credit of $5 that can be used freely in a casino hotel, a second type of second credit of $10 that is effective until 1 pm only at the slot machine, and a third type of second credit of $8 that is effective until 6 pm only at the slot machine. In this case, the transaction management apparatus 100 allows a transaction of up to $23 at noon, a transaction of up to $13 at 3 pm, and then allows a transaction of up to $5 after 6 pm.

The transaction requesting apparatus 200 may send the balance request containing the name of goods or services for which the user intends to use second credit before sending the transaction request to the transaction management apparatus 100. In the transaction management apparatus 100, the managing section 140 searches the storing section 120 to pick out a plurality of second credits that can be used for the purchase of the goods or services that correspond to the name of the goods or services contained in the balance request. The managing section 140 sends the total amount of a plurality of second balances of the extracted second credits to the transaction requesting apparatus 200. By the transaction requesting apparatus 200 displaying the received total amount, the user is able to easily figure out whether or not the user can buy the goods or services that is under consideration for a purchase.

As described above, by making it possible for the transaction management system 10 to use a combination of a plurality of second credits each with different use conditions, the intention of the company that issues second credit is satisfied, and the user is able to utilize second credit to the maximum extent.

[Tallying the Service Usage Amount of the Second Credit]

The transaction management apparatus 100 may tally the service usage amount that the company using the transaction management system 10 uses for second credit. Specifically, the managing section 140 may tally at least one of the amount or the number of times second credit was used, corresponding to the issuer of the second credit.

Specifically, the managing section 140 stores the second balance in association with the issuer of the second credit to the storing section 120. For example, when the managing section 140 receives the recharge transaction request of second credit, the managing section 140 stores the transaction requesting amount in association with the issuer of the transaction request to the storing section 120. The managing section 140 may store the archival record to the storing section 120, that shows the second credit corresponding to the issuer being recharged and used, and may output these archival records.

The managing section 140 may calculate at least one of the decreased amount and the increased amount of the second balance in association with the issuer of second credit within a predetermined period. The managing section 140 may calculate the number of times that second credit was used within a predetermined period with respect to each of the issuers of second credit. The operator of the transaction management system 10 may take a service charge that corresponds to the used amount of second credit issued by the company using the transaction management system 10, or may take a service charge corresponding to the number of times that second credit was used.

The managing section 140 may tally the used amount, or the number of times that second credit was used, further matching the use conditions of the second credit. For example, the managing section 140 calculates the different charge depending on the type of goods or services, shops, and areas, etc. for which second credit can be used.

As described above, since the transaction management system 10 can tally the service charges for each company that uses the transaction management system 10, the transaction management system 10 can be utilized by many companies.

[Forbidding the Transaction According to the Accumulated Amount of Transactions]

In order to prevent a user from using excessive amounts of local credit, the managing section 140 may store in the storing section 120, in association with the identification information, (i) the accumulated amount of the transactions carried out by the user within the predetermined period of time, and (ii) the accumulated usable balance that can be used by the user within the predetermined period. The judging section 130 judges whether or not the transaction is allowed based on the total sum of the accumulated and transaction requesting amount, and the accumulated usable balance. The managing section 140 may store the accumulated amount in the storing section 120, the accumulated amount being obtained by deducting the amount that was exchanged to cash, from the amount of the transaction.

Specifically, when the sum of the transaction requesting amount and the accumulated amount within the predetermined period is less than or equal to the accumulated usable balance that can be used within the predetermined period, the judging section 130 allows the transaction. When the sum of the transaction requesting amount and the accumulated amount within the predetermined period is larger than the accumulated usable balance that can be used within the predetermined period, the judging section 130 does not allow the transaction.

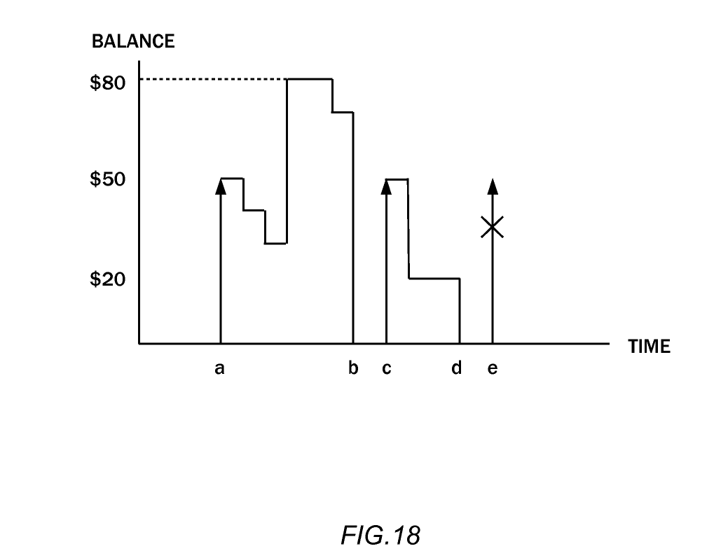

FIG. 18 shows an example of the relationship between the time and the balance of local credit. The horizontal axis shows the time, and the vertical axis shows the balance of first credit at each time. For example, at time “a,” the user that plays at a slot machine sets the play amount at $50 by using the wireless information terminal 300. The wireless information terminal 300 sends the transaction request with the play amount of $50 as the transaction requesting amount to the transaction management apparatus 100. When the transaction management apparatus 100 allows the transaction, the user can play at a slot machine by using up to $50 corresponding to the usable balance.

In FIG. 18, the user wins after using $10 twice, and the usable balance is increased to $80 by adding $50 as a prize. Next, the user uses $10 and then uses $70, and the usable balance becomes $0 at time “b.” At time “c,” the user adds the play amount of $50 by using the wireless information terminal 300. After that, the user uses $50, and the usable balance at time “d” becomes $0.

In the case of the above mentioned example, for example, the managing section 140 calculates the accumulated amount of the transaction between time “a” and time “d” as $50+$50=$100, and stores the calculated accumulated amount to the storing section 120. When the judging section 130 receives the transaction request, the judging section 130 reads out the accumulated amount and the accumulated usable balance that are stored in the storing section 120.

Here, at time “e,” suppose that the user intends to add an additional $50 as the play amount by using the wireless information terminal 300. The wireless information terminal 300 sends the transaction request with the transaction requesting amount of $50 to the transaction management apparatus 100, and the request receiving section 110 receives that transaction request. The judging section 130 reads out the accumulated usable balance of first credit of $100 that the user can use before time “e”, and the accumulated amount of $100 at time “e” from the storing section 120. Since the accumulated amount during this period has reached the accumulated usable balance, the judging section 130 does not allow the transaction at time “e.”

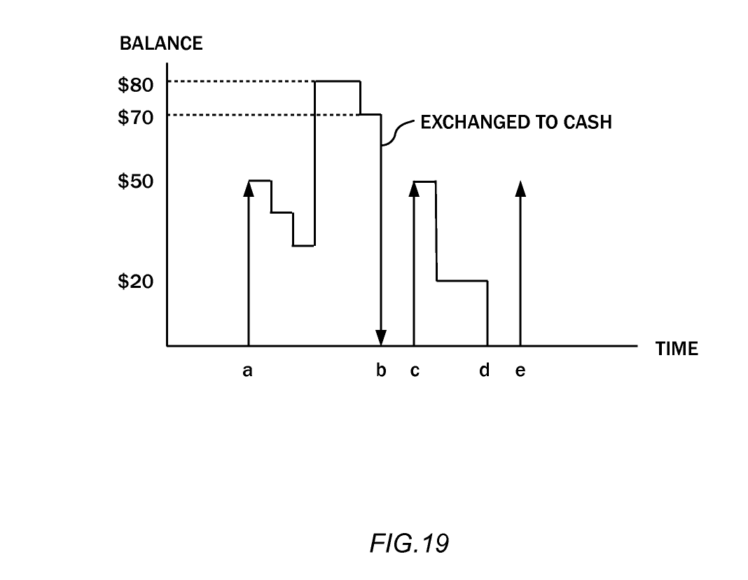

FIG. 19 shows another example of the relationship between the time and the balance of local credit. In FIG. 19, at time “b,” the user exchanges $70 of the usable balance to cash. In this manner, when the user exchanges the usable balance of first credit to cash, the managing section 140 may store the accumulated amount in the storing section 120, the accumulated amount being obtained by deducting an amount that is exchanged to cash from the amount of the transaction.

Since the first credit was not used for playing a slot machine, the managing section 140 calculates the accumulated amount by deducting the amount being exchanged to cash. For example, in the case of the example of FIG. 19, the managing section 140 calculates the accumulated amount by running the calculation of $50 (time “a”)−$70 (time “b”)+$50 (time “c”)=$30, and stores to this figure to the storing section 120. When the request receiving section 110 receives the transaction request containing the play amount of $50 as the transaction requesting amount at the time “e,” the judging section 130 allows the transaction since the total amount of the accumulated amount and the transaction requesting amount is less than the accumulated usable balance.

The transaction management apparatus 100 may determine the balance with which a transaction can be conducted during a predetermined period, depending on the type of local credit. Specifically, the managing section 140 stores the first accumulated amount of first credit being used during the predetermined period, the second accumulated amount of second credit being used during the predetermined period, the first accumulated usable balance of first credit that can be used during the predetermined period, and the second accumulated usable balance of second credit being used during the predetermined period, to the storing section 120. These are all stored in association with the identification information.

For example, since it is often the case that second credit is provided by a company that uses the transaction management system 10 for free, the managing section 140 makes the second accumulated usable balance larger than the first accumulated usable balance. In another aspect, the managing section 140 may make the second accumulated usable balance smaller than the first accumulated usable balance. Or in a further aspect, the managing section 140 may set only the accumulated usable balance of the first credit or the second credit purchased by the user in cash, or by a payment with a credit card.

As described above, the transaction management system 10 has the advantage of being able to prevent a user from consuming excessive amount of money in a casino by judging whether or not a transaction is allowed according to the accumulated amount of the transaction during a predetermined period. Also, since the transaction management system 10 is able to prevent a user from using a large amount of second credit that was illegally acquired from a third party, the transaction management system 10 is advantageously able to prevent the company that issues second credit from suffering a loss.

[Providing Local Credit to the User that Introduces Local Credit to Other Users]

The transaction management system 10 may provide local credits to the user that introduces the application software to use local credit to other users. Specifically, the wireless information terminal 300 in which the application software to use the transaction management system 10 is installed, according to an operation of the first user of the wireless information terminal 300, notifies a second user with the information for specifying the web site for downloading the application software (for example, a URL) and the user's identification information by sending them to the wireless information terminal 300 of the second user that has not yet installed the application software.

The wireless information terminal 300 of the second user sends the message that requests the application software and the identification information of the first user to the transaction management apparatus 100. The transaction management apparatus 100 corresponds to the URL received from the wireless information terminal 300 of the first user. The transaction management apparatus 100 sends the application software to the wireless information terminal 300 of the second user and increases the local credit corresponding to the first user's identification information.

Thus, the number of users of the transaction management system 10 can be increased.

[Forbidding Recharges with the Wireless Information Terminal 300 in Specific Areas]

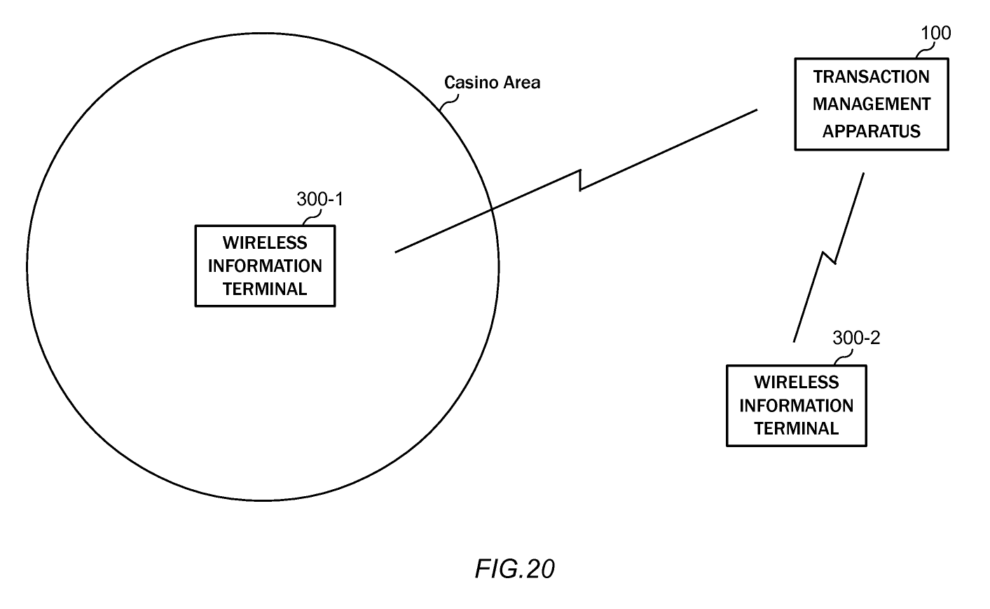

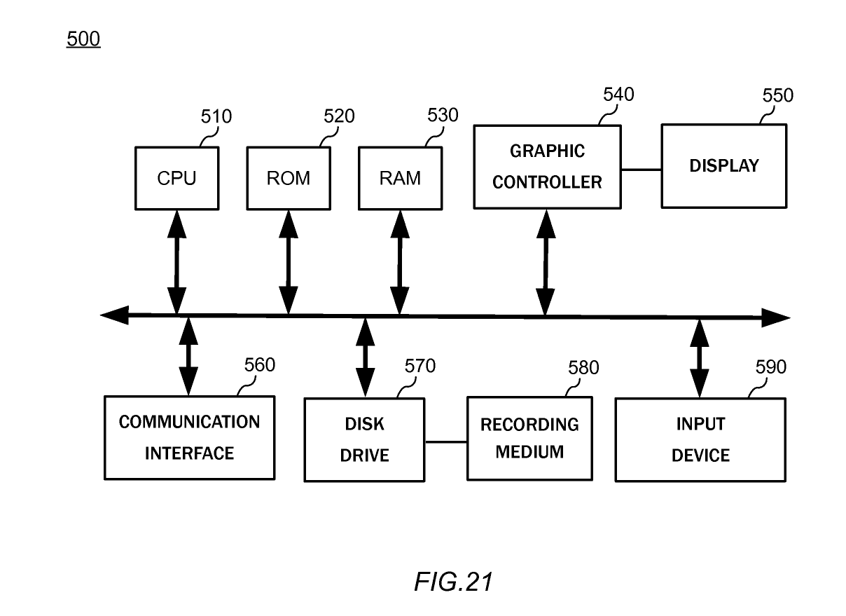

FIG. 20 shows an example of the location of the wireless information terminal 300 that functions as a transaction requesting apparatus 200. The wireless information terminal 300-1 shows that the user is playing at the slot machine, and that the user is located in the casino-area where playing apparatuses such as slot machines are installed. The wireless information terminal 300-2 shows that the user is located outside of the casino-area.

The transaction management system 10 may forbid transactions when the wireless information terminal 300 is located in a predetermined area, in order to prevent the user from over-consuming money at a playing apparatus such as a slot machine. Specifically, the transaction management system 10 may forbid the recharge transaction increasing the first balance of first credit by using the wireless information terminal 300. For example, when the wireless information terminal 300 detects the predetermined beacon signal, the screen for inputting the transaction requesting amount is not displayed. When the user conducts an operation to recharge the first credit, the wireless information terminal 300 may display that recharging cannot be done.

The wireless information terminal 300 may judge whether or not the transaction should be forbidden according to the wireless network ID that is acquired at the time of the radio communication. For example, the wireless information terminal 300 judges whether or not the transaction should be forbidden based on the identification information of the wireless router. The wireless information terminal 300 may acquire the location information, and may judge whether or not the transaction should be forbidden, based on the location information.

As described above, the transaction management system 10 is able to prevent the overly enthusiastic user from continuing to play with a slot machine, and from using excessive amount of money by forbidding the recharging of local credit, using the wireless information terminal 300 in predetermined areas.

[Configuration of the Transaction Management Apparatus 100 or the Transaction Requesting Apparatus 200 with Computers]

FIG. 21 shows an example of the computer 500 that functions as the transaction management apparatus 100 or the transaction requesting apparatus 200. The computer 500 may function as the wireless information terminal 300. The computer 500 has a CPU 510, a ROM 520, a RAM 530, a graphic controller 540, a display 550, a communication interface 560, a disc-drive 570, a recording medium 580, and an input device 590. In the computer 500, by the CPU 510 reading out and executing the program stored in the 580, the computer 500 functions as the transaction management apparatus 100, the transaction requesting apparatus 200, or the wireless information terminal 300.

The CPU 500 may function as the transaction management apparatus 100, the transaction requesting apparatus 200 or the wireless information terminal 300 by reading out the program that is stored in the recording medium 580 such as a hard-disk or a CD-ROM through the disc-drive 570. The CPU 500 may function as the transaction management apparatus 100, the transaction requesting apparatus 200, or the wireless information terminal 300 by executing the program that is downloaded from other computers through the communication interface 560.

Specifically, the CPU 500 functions as at least one of the judging section 130 and the managing section 140 in the transaction management apparatus 100 by executing the program. The CPU 500 may function as the control section 250 in the transaction requesting apparatus 200 by executing the program.

The RAM 530 functions as the storing section 120 in the transaction management apparatus 100. The display 550 functions as the display section 240 in the transaction requesting apparatus 200. The communication interface 560 functions as the request receiving section 110 in the transaction management apparatus 100, or functions as the sending section 220 and the receiving section 230 in the transaction requesting apparatus 200. The input device 590 functions as the acquiring section 210 in the transaction requesting apparatus 200.

### Effects of the Present Embodiment

As described above, in accordance with the present embodiment, since the first credit that can be used in a company that introduces the transaction management system 10 and the second credit with a different usable range from the first credit are managed for each user, a company that introduces the transaction management system 10, and a shop that uses the transaction management system 10 are advantageously able to lock-in users and motivate them to purchase new goods or services.

While the present invention has been explained with the embodiment, the technical scope of the present invention is not limited to the embodiment. It will be apparent to those persons skilled in the art that variations and modifications may be made in the embodiment. Also, it is apparent from the appended claims that such variations and modifications all are included within the technical scope of the present invention.

1. A transaction management apparatus that manages transactions of local credits that can be used by a user in a limited environment, comprising:
a memory configured to store a first balance and a second balance, in association with the identification information, the first balance indicating a balance of a first credit that can be exchanged both to and from, only from, or only to cash and the second balance indicating a balance of a second credit that can neither be exchanged from cash nor be exchanged to cash, and
a processor configured to:
receive a transaction request containing a transaction requesting amount indicating an amount of the transaction; identification information unique to the user; wherein the transaction requesting amount comprises a first transaction requesting amount to be drawn from the first balance and a second transaction requesting amount to be drawn from the second balance;
judge whether or not the transaction is allowed based on a result of comparing the first transaction requesting amount with at least one of the first balance corresponding to the identification information and comparing the second transaction requesting amount with the second balance corresponding to the identification information; and
update at least one of the first balance and the second balance stored in the memory based on the transaction requesting amount, when the transaction is allowed.

2. (canceled)

3. The transaction management apparatus according to claim 1, wherein the processor is further configured to allow the first credit to be exchanged to cash when the first credit was obtained by being exchanged from cash, and does not allow the first credit to be exchanged to cash when the first credit was obtained by using a credit card.

4. The transaction management apparatus according to claim 1, wherein the processor is further configured to:
judge whether or not the transaction is allowed based on at least one of (i) a result of comparing the first transaction requesting amount with the first balance corresponding to the identification information and (ii) a result of comparing the second transaction request amount with the second balance corresponding to the identification information; and
conduct at least one of (i) changing the first balance stored in the memory according to the first transaction requesting amount and (ii) changing the second balance stored in the memory according to the second transaction requesting amount, when the transaction is allowed.

5. The transaction management apparatus according to claim 1, wherein the processor is further configured to:
deduct a difference between the transaction requesting amount and the second balance, from the first balance, and
set a value of the second balance to 0, when the transaction requesting amount is larger than the second balance and smaller than the sum of the first balance and the second balance.

6. The transaction management apparatus according to claim 1, wherein the processor is further configured to;
receive the transaction request containing at least one of use condition selected from the group consisting of types of goods or services that are purchased by the second credit, types of companies that provide the goods or services, types of shops that provide the goods or services, areas in facilities that provide the goods or services, a time-zone in which the goods or services are purchased, and an effective time period of the second credit during which the goods and services are purchased; and
judge, according the use conditions, (i) which of the first credit and the second credit should be used, (ii) whether or not both the first credit and the second credit should be used, or (iii) which portions of the first credit and the second credit should be used, and changes the first balance and the second balance selected based on a result of the judgment, according to the transaction requesting amount.

7. The transaction management apparatus according to claim 1, wherein the processor is further configured to:
receive the transaction request containing the use condition of the second credit and the transaction requesting amount matching the use condition, wherein the use condition is selected from the group consisting of types of goods or services that are purchased by the second credit, types of companies that provide the goods or services, types of shops that provide the goods or services areas in facilities that provide the goods or services, a time-zone in which the goods or services are purchased, and an effective time period of the second credit during which the goods and services are purchased;
store at least one of second balances, in association with the use condition of the second credit; and
judge whether or not the transaction is allowed based on a result of comparing the transaction requesting amount matching the use condition contained in the transaction request with at least one of the second balances matching the use condition.

8. The transaction management apparatus according to claim 7, wherein the processor is further configured to:
deduct a difference between the transaction requesting amount and the second balance, from the first balance, and
set a value of the second balance to 0, when the transaction requesting amount matching the use condition is larger than the second balance matching the use condition, and smaller than the sum of the first balance and the second balance.

9. The transaction management apparatus according to claim 7, wherein the processor is further configured to, when at least one of the first balance and the second balance is updated in response to the transaction request containing a first use condition, increase the second balance corresponding to a use condition for other than the first use condition, according to the transaction requesting amount corresponding to the first use condition.

10. The transaction management apparatus according to claim 7, wherein the processor is further configured to increase the second balance according to the transaction requesting amount and the first balance and the second balance, in a case where at least one of the first balance and the second balance is within a range of a predetermined amount when at least one of the first balance and the second balance is updated.

11. The transaction management apparatus according to claim 7, wherein the processor is further configured to:
store in the memory, in association with the identification information, an effective period indicating a period of time during which the second credit can be used, as one of the use conditions; and
judge whether or not the transaction is allowed reckoning the effective period in consideration, and
update the second balance after the effective date is expired.

12. The transaction management apparatus according to claim 1, wherein the processor is further configured to tally at least one of an amount of the second credit and a number of times of using the second credit is used on each issuer of the second credit.

13. The transaction management apparatus according to claim 1, wherein the processor is further configured to:
store in the memory, in association with the identification information, (i) an accumulated amount of the transaction of the first credit that is carried out in a play by using the first credit by the user with the identification information within a predetermined period of time and (ii) an accumulated usable balance that is able to be used by the user with the identification information within the predetermined period of time; and
judge whether or not the transaction is allowed in the play based on the accumulated usable balance, and a sum of the transaction requesting amount and the accumulated amount.

14. The transaction management apparatus according to claim 13, wherein the processor is further configured to store the accumulated amount in the memory, the accumulated amount being obtained by deducting an amount that is exchanged to cash, from an amount of the transaction.

15. A transaction requesting apparatus comprising a processor configured to:
acquire an instruction regarding transactions of local credits that can be used by a user in a limited environment said instruction comprising transaction requesting amount comprises a first transaction requesting amount to be drawn from a first balance and a second transaction requesting amount to be drawn from a second balance;
send, according to the instruction, a balance request for the first balance indicating a balance of a first credit that can be exchanged both to and from, only from, or only to cash and the second balance indicating a balance of a second credit that can neither be exchanged from cash nor be exchanged to cash, to a transaction management apparatus that manages the first balance and the second balance;
receive the first balance and the second balance from the transaction management apparatus; and
display at least one of the first balance and the second balance.

16. The transaction requesting apparatus according to claim 15, wherein the processor is further configured to:
according to the instruction from the user, send to the transaction management apparatus a transaction request containing (i) the transaction requesting amount indicating a money amount requested in a transaction; (ii) the identification information; and (iii) a use condition selected from the group consisting of types of goods or services that are purchased by the second credit, types of companies that provide the goods or services, types of shops that provide the goods or services, areas in facilities that provide the goods or services, a time-zone in which the goods or services are purchased, and an effective time period of the second credit during which the goods and services are purchased.

17. The transaction requesting apparatus according to claim 16, wherein the processor is further configured to:
allow a user to play by using at least one of the first credit and the second credit,
acquire a play amount indicating an expected amount to be used in association with each of the first credit and the second credit after the at least one of the first balance and the second balance is displayed;
send the transaction request containing the play amount that uses the first credit and the play amount that uses the second credit as the transaction requesting amount, to a transaction management apparatus;
receive, from the transaction management apparatus, (i) a first usable balance of the first balance corresponding to the identification information of the user that can be used in the play and (ii) a second usable balance of the second balance corresponding to the identification information of the user that can be used in the play; and
carry out the play while a fee required for the play is less than or equal to a total amount of the first usable balance and the second usable balance after receiving an instruction to begin the play from the user.

18. The transaction requesting apparatus according to claim 17, wherein the processor is further configured to:
display a plurality of play amount options in a combination of a whole or part of the first balance and a whole or part of the second balance; and
acquire a play amount option selected among the plurality of play amount options as the play amount.

19. The transaction requesting apparatus according to claim 16, wherein the processor is further configured to:
display, in association with a use condition, at least one of the first balance and the second balance that can be used under the use condition.

20. The transaction requesting apparatus according to claim 19, wherein the processor is further configured to display a total amount of a plurality of second balances that can be used under the use condition.

21. A transaction management system comprising:
a transaction requesting apparatus comprising a processor which is configured to request transactions of local credits that can be used by a user in a limited environment; and
a transaction management apparatus comprising a processor which is configured to judge whether or not a transaction is allowed in response to a transaction request received from the transaction requesting apparatus, wherein
the processor in the transaction requesting apparatus is further configured to send the transaction request containing identification information of the user and a transaction requesting amount of the transaction, said transaction requesting amount comprises a first transaction requesting amount to be drawn from a first balance and a second transaction requesting amount to be drawn from a second balance, and
the processor in the transaction management apparatus includes: is further configured to:
store the first balance and the second balance, in association with the identification information, the first balance indicating a balance of a first credit that can be exchanged both to and from, only from, or only to cash and the second balance indicating a balance of a second credit that can neither be changed from cash nor be exchanged with cash;
judge whether or not the transaction is allowed based on a result of comparing the transaction requesting amount with the first balance and the second balance corresponding to the identification information; and
update the stored first balance and the second balance based on the transaction requesting amount, when the transaction is allowed.

22. The transaction management system according to claim 21, wherein the processor in the transaction requesting apparatus is further configured to:
acquire instructions from the user;
receive the first balance and the second balance from the transaction management apparatus the second balance being associated with a use condition of the second credit, wherein the use condition is selected from the group consisting of types of goods or services that are purchased by the second credit, types of companies that provide the goods or services, types of shops that provide the goods or services, areas in facilities that provide the goods or services, a time-zone in which the goods or services are purchased, and an effective time period of the second credit during which the goods and services are purchased; and
display the first balance and the second balance, and
send the identification information unique to the user and a balance request for the first balance indicating a balance of the first credit and for the second balance indicating a balance of the second credit associated with the use condition, to the transaction management apparatus, in response to an instruction from the user, wherein
the processor in the transaction management apparatus is further configured to:
send the first balance and the second balance to the transaction requesting apparatus in response to the balance request; and
acquire the transaction requesting amount associated with the use condition from the user after at least one of the first balance and the second balance is displayed.

23. The transaction management system according to claim 21, further comprising:
a wireless information terminal that functions as the transaction requesting apparatus, wherein
the wireless information terminal displays the first balance and the second balance received from the transaction management apparatus, and acquires the transaction requesting amount and a use condition of the second credit from the user, the second balance being associated with a use condition of the second credit, wherein the use condition is selected form the group consisting of types of goods or services that are purchased by the second credit, types of companies that provide the goods or services, types of shops that provide the goods or services, areas in facilities that provide the goods or services, a time-zone in which the goods or services are purchased, and an effective time period of the second credit during which the goods and services are purchased;
the processor in the transaction requesting apparatus is further configured to:
acquire the transaction requesting amount and the use condition of the second credit from the wireless information terminal, and
send the transaction request containing the transaction requesting amount, and
the processor in the transaction management apparatus is further configured to:
update the stored first balance and the second balance in association with the identification information, based on the transaction requesting amount.

24. The transaction management system according to claim 23, wherein
the wireless information terminal forbid the recharge transaction that increase the first balance of the first credit when the wireless information terminal is located in a predetermined area.

25. The transaction management system according to claim 21, wherein the processor in the transaction management apparatus is further configured to deduct a difference between the transaction requesting amount and the second balance, from the first balance, and
set a value of the second balance to 0, when the transaction requesting amount is larger than the second balance and smaller than the sum of the first balance and the second balance.
